(19) United States
(12) Patent Application Publication
(10) Pub. No.: US 2022/0130247 A1
(43) Pub. Date: Apr. 28, 2022

(54) INTELLIGENT LOCK DATABASE SYSTEM BASED ON UNIQUELY MARKED LOCATION AND LONGITUDE AND LATITUDE

(71) Applicant: Xi'an Shiyun Transportation Equipment Co., Ltd., Xi'an (CN)

(72) Inventor: Jian LIU, Xi'an (CN)

(73) Assignee: Xi'an Shiyun Transportation Equipment Co., Ltd., Xi'an (CN)

(21) Appl. No.: 17/549,897

(22) Filed: Dec. 14, 2021

Related U.S. Application Data
(63) Continuation of application No. PCT/CN2020/000294, filed on Dec. 9, 2020.

(30) Foreign Application Priority Data
Dec. 9, 2019 (CN) 201911334275.8

(51) Int. Cl. G08G 1/14; G06F 16/29; G06F 16/22

(52) U.S. Cl. CPC G08G 1/142; G06F 16/2282; G06F 16/29; G08G 1/145

(57) ABSTRACT

An intelligent lock database system based on uniquely marked location and longitude and latitude, the area contains a number of uniquely marked locations, and the ID locations are bound with the longitude and latitude of the ID locations one to one and stored in the table of ID locations and longitude and latitude of ID Locations in the database: the ID mobile phone can open or close the ID intelligent lock through the server only when the longitude and latitude of the ID location correspond to the longitude and latitude of the ID intelligent lock one to one and when the longitude and latitude of the ID location correspond to the longitude and latitude of the ID mobile phone one to one; the ID mobile phone is uploaded to the server, and the server compares the longitude and latitude of the ID mobile phone.

### CROSS-REFERENCE TO RELATED APPLICATIONS

The application claims priority to Chinese patent application No. 201911334275.8, filed on Dec. 9, 2019, the entire contents of which are incorporated herein by reference.

### TECHNICAL FIELD

A method for unlocking or locking of a lock based on location marking or geographical location, a parking lot lock or an express mailbox lock based on location marking or geographical location; a method for management of shared cars, shared electric vehicles and shared bicycles at parking spaces based on location marking or geographical location.

### BACKGROUND

Existing parking lots only have the parking lot location. There is a computer system recording the data of full parking lot or non-full parking lot in real time, and a timer recording the number of non-full parking spaces and displaying it on the display screen at the entrance and exit of the parking lot. The recorded data of full parking lot or non-full parking lot and the number of non-full parking spaces are not transmitted to the driver’ mobile phone APP, which makes it difficult for the driver to choose to park in the non-full parking lot when parking. A computer program method based on vehicle marking (QR code) of shared bicycles, which consists of electronic map, vehicle unit intelligent lock, background system, wireless network and passenger mobile phone APP. Existing stations of shared bicycles only have the station location. There is no unique marking or indication whether the station is full or non-full, causing road congestion when the bicycles are parked at a full station; at the same time, the bicycles parked outside the station are not displayed on the electronic map, resulting in disorderly parking, missing bicycles and losses to operators.

### SUMMARY

In order to overcome the problems of disorderly parking, missing bicycles and losses to operators, an intelligent lock database system based on uniquely marked location and longitude and latitude is invented, which is characterized by;

The area contains a number of uniquely marked gathering stations which are expressed as ID gathering stations, each ID gathering station contains at least one uniquely marked location which is expressed as ID location, and each ID location contains at least one uniquely marked sub-location which is expressed as ID sub-location;

The longitude and latitude of the ID gathering station are measured on the spot by using the longitude and latitude positioning system, all ID gathering stations in the whole area are bound with the longitudes and latitudes of such ID gathering stations one to one and are included in the table of ID gathering stations and their longitudes and latitudes, and the table is stored in the database; the longitude and latitude positioning system consists of the satellite navigation system, i.e. China's Beidou navigation satellite system BDS, BDS positioning system and GPS positioning system; the following abbreviation herein includes GPS system; the longitude and latitude of the ID location are measured on the spot by using the GPS positioning system (including BDS measuring instrument or GPS measuring instrument), all ID locations in the ID gathering station are bound with the longitudes and latitudes of such ID locations one to one and are included in the table of ID locations and their longitudes and latitudes, and the table is stored in the database; there is a one-to-one corresponding uniquely marked intelligent lock at the ID location, and such uniquely marked intelligent lock is represented as an ID intelligent lock, that is, the longitude and latitude of the ID location are in a one-to-one corresponding relation with those of the ID intelligent lock; the ID intelligent lock is a microcomputer which consists of CPU, motherboard, memory cell, input and output units, and wireless network card; the function is to send information to the server and receive instructions from the server, and to connect the industrial control unit to open or close the lock switch; the server is equipped with Beidou assistant, Beidou companion positioning system and GPS positioning system;

It consists of a plurality of uniquely marked mobile phones, which are represented as ID mobile phones. The ID mobile phone is equipped with Beidou assistant, Beidou companion positioning system module and GPS positioning system module; at the same time, the ID mobile phone is equipped with a SIM card; the said ID intelligent lock, ID mobile phone and GPS system communicate with the server through a wired or wireless network; the method for the ID mobile phone to open or close the ID intelligent lock through the server is as follows: only when the longitude and latitude of the ID location correspond to those of the ID intelligent lock one to one, and the longitude and latitude of the ID location correspond to those of the ID mobile phone one to one, the ID mobile phone can open or close the ID intelligent lock through the server; that is, the ID mobile phone uploads the longitude and latitude of the ID mobile phone, and the ID mobile phone to the server through the GPS positioning system, the server compares the longitude and latitude of the ID mobile phone, i.e. the uploaded longitude and latitude of the ID location with the table of ID locations and their longitudes and latitudes. Only when the uploaded longitude and latitude of the ID location correspond to those of a certain ID location in the table of ID locations and their longitudes and latitudes one to one, the instruction to open or close the ID intelligent lock can be sent to the ID intelligent lock corresponding to the longitude and latitude of the ID location.

An intelligent lock database system with uniquely marked delivery station and longitude and latitude, which is characterized in that: it is applicable to the intelligent lock database system based on uniquely marked location and longitude and latitude as said in claim 1;

The whole area is provided with a plurality of delivery stations, each delivery station is registered as a uniquely marked delivery station and represented as an ID delivery station, and the longitude and latitude of the ID delivery station are measured on the spot. All ID delivery stations in the whole area are bound with the longitudes and latitudes of such ID delivery stations one to one and are included in the table of ID delivery stations and their longitudes and latitudes, and the table is stored in the database; each ID delivery station is provided with at least one ID location, the longitude and latitude of the ID location are measured on the spot, all ID locations in the delivery station are bound with the longitudes and latitudes of such ID locations one to one and are included in the table of ID locations and their longitudes and latitudes, and the table is stored in the database; each ID location is provided with a plurality of sub-locations, the sub-location is provided with a unique code and represented as an ID sub-location; each ID sub-location is provided with a mailbox, and the mailbox is provided with an ID sub-intelligent lock; the ID delivery station is provided with an ID delivery station computer; the ID delivery station computer is connected with the ID sub-intelligent lock; the mailbox ID sub-intelligent lock is opened or closed through the industrial control unit; it consists of CPU, motherboard, memory cell, input and output units, and wireless network card; the function is to upload information of ID delivery station computer and ID sub-intelligent lock and receive instructions from the server, and only one ID mail of the ID mobile phone can be placed in one sub-location;

Each ID sub-location (mailbox) is bound with the ID sub-intelligent lock; the said mailbox may include an intelligent lock for the milk delivery box and home door; the customer's mobile phone is represented as an ID mobile phone, and the customer's uniquely marked mail is represented as an ID mail;

The staffs mobile phone, ID mobile phone, ID delivery station computer, GPS system and server communicate with each other through wireless network;

Procedure for delivering the mail: The staff puts the ID mail into the ID sub-location mailbox and locks the ID sub-intelligent lock of the ID sub-location, which is referred to as the ID sub-intelligent lock; the staff records the ID mobile phone, ID delivery station, ID delivery station computer, ID location, ID sub-location (mailbox), ID sub-intelligent lock and ID mail into the table of ID mobile phones and ID locations (see Table 11) using his/her mobile phone, and uploads the table to the server and stores it in the database, and then the server transmits the table to the customer's ID mobile phone; Table 11:

| | | | Longitude | | | | | | |
|---|---|---|---|---|---|---|---|---|---|
| | Longitude | | and | | | Longitude | | | |
| | and | | latitude of | ID | | and | | | |
| ID | latitude of | ID | ID | delivery | | latitude of | | ID sub- | |
| mobile | ID mobile | delivery | delivery | station | ID | ID | ID sub- | intelligent | ID |
| phone | phone | station | station | computer | location | location | location | lock | mail |
| , , , | , , , | , , , | , , , | , , , | , , , | , , , | , , , | , , , | , , , |

Procedure for taking the mail: After receiving the table, the customer stands on the ID location according to the ID delivery station indicated in the table, presses the mail taking key on the ID mobile phone, and the customer's ID mobile phone uploads the ID mobile phone and the longitude and latitude of the ID mobile phone to the server, in which the longitude and latitude of the ID mobile phone is the longitude and latitude of the ID location; (1) the server compares the longitude and latitude of the uploaded ID mobile phone with the table of ID mobile phones and ID locations (see Table 2), the longitude and latitude of the ID mobile phone correspond to those of a certain ID location in the table, and the ID sub-location can be obtained; (2) the server compares the uploaded ID mobile phone with the table of ID mobile phones and ID locations (see Table 11). If the uploaded ID mobile phone belongs to the ID sub-location for placing the ID mail of the ID mobile phone given in the table of ID mobile phones and ID locations, an unlocking instruction will be sent to the ID sub-intelligent lock corresponding to the ID sub-location bound with the ID mobile phone given in the table in the ID delivery station computer; then the ID sub-intelligent lock at the ID sub-location is opened, and the customer can take out the ID mail. An intelligent lock database system with uniquely marked parking lot and longitude and latitude, which is characterized in that: it is applicable to the intelligent lock database system based on uniquely marked location and longitude and latitude as said in claim 1;

The whole area is provided with two or more parking lots, each parking lot is registered as a uniquely marked parking lot and represented as an ID parking lot, and the longitude and latitude of the ID parking lot are measured on the spot. All ID parking lots in the whole area are bound with the longitudes and latitudes of such ID parking lots one to one and are included in the table of ID parking lots and their longitudes and latitudes (see Table 1), and the table is stored in the database;

Each ID parking lot contains at least one uniquely marked parking space which is expressed as ID parking space; the longitude and latitude of the ID parking space are measured on the spot; the ID parking spaces are bound with the longitude and latitude of the ID parking spaces one to one and included in the table of ID parking spaces and longitude and latitude of ID parking spaces (see Table 2); the table is stored in the database; each ID parking space is composed of at least one uniquely marked sub-parking space which has a unique code and expressed as ID sub-parking space; 1 sub-parking space can only be occupied by one vehicle;

The ID parking lot is provided with an ID parking lot computer; the ID parking lot computer is referred to as the ID intelligent lock; it consists of CPU, motherboard, memory cell, input and output units, and wireless network card; the function is to upload information of ID parking space and ID vehicle and receive instructions from the server, and to connect the industrial control unit to open or close the gate switch at the entrance and exit of ID parking lot;

The ID intelligent lock is connected with the industrial control module to control the opening and closing of the entrance and exit lock of the ID parking lot, and is provided with a SIM card and a longitude and latitude positioning system module; the ID intelligent lock is also called ID parking lot;

When all parking spaces of a ID parking lot are fully occupied, the ID parking lot is considered as a full parking lot, and all full parking lots are included in the table of full parking lots (see Table 3); the table is stored in the database; when at least one parking space of the ID parking lot is not occupied, the ID parking lot is considered as a non-full parking lot, and all non-full parking lots are included in the table of non-full parking lots (see Table 4); the table is stored in the database;

When all sub-parking spaces of a parking space are occupied sub-parking spaces, the ID parking space is considered as an occupied parking space, all occupied parking spaces in the whole area are included in the occupied parking spaces in the table of full and non-full parking lots (see Table 3), and the table is stored in the database; when the ID is occupied and at least one sub-parking space is unoccupied sub-parking space, the ID parking space is considered as an unoccupied parking space, and all unoccupied parking spaces are included in the unoccupied parking spaces in the Table of Non-full Parking Lot (see Table 3); the table is stored in the database;

It consists of a plurality of drivers' mobile phones, which are represented as ID mobile phones. The ID mobile phone is provided with SIM card and GPS system module; the ID parking lot computer, ID mobile phone and GPS system are connected to the server with the wireless network;

When the driver enters, he/she presses the key of entering the parking lot on the ID mobile phone or uses the ID mobile phone to scan the (QR code) of the ID parking lot, and uploads the longitude and latitude of the ID mobile phone to the server, then the server compares them with the table of ID parking lots and longitudes and latitudes of ID parking lot computer; only when the longitude and latitude of the ID parking lot correspond to those of the ID mobile phone one to one, the ID parking lot can be obtained; if the ID parking lot belongs to the table of non-full parking lots, the server will send an instruction to open the gate to the ID parking lot computer, then the ID mobile phone can open the entrance gate switch of ID parking lot computer; the ID parking lot computer is provided with an industrial control module, which is connected with the entrance gate switch of the parking lot to control it. When the ID parking lot computer receives the instruction from the server to open the gate, its industrial control module will control to open the gate of the ID parking lot, and vice versa.

An intelligent lock database system for uniquely marked station and longitude and latitude, which is characterized by: it is suitable for the intelligent lock database system based on uniquely marked location and longitude and latitude as said in claim 1; (used for shared bicycles and shared cars)

The whole area is provided with two or more stations, each station is registered as a uniquely marked station and represented as an ID station, and the longitude and latitude of the ID station are measured on the spot; all ID stations in the whole area are bound with the longitudes and latitudes of such ID stations one to one and are included in the table of ID stations and their longitudes and latitudes (see Table 1), and the table is stored in the database;

Each ID station consists of at least one uniquely marked parking space, which is represented as an ID parking space; the longitude and latitude of the ID parking space are measured on the spot; the ID parking space is bound with the longitude and latitude of the ID parking space one to one and is included in the table of ID parking space and its longitude and latitude (see Table 2); the table is stored in the database; each ID parking space consists of at least one uniquely marked sub-parking space, which is represented as an ID sub-parking space, and only one vehicle can be parked at each ID sub-parking space;

When all parking spaces of an ID station are full, the ID station is represented as a full station, and all of these full stations are included in the table of full stations (see Table 3); the table is stored in the database; when at least one sub-parking space of the ID parking space is unoccupied, the ID parking space is an non-full parking space; when at least one parking space at the ID station is not full, the ID station is an non-full station, and all of these non-full stations are included in the table of non-full stations (see Table 4); and the table is stored in the database;

It consists of two or more intelligent locks, each intelligent lock is registered as a uniquely marked intelligent lock and represented as an ID intelligent lock; the ID intelligent lock is arranged on the uniquely marked vehicle, the unique mark contains a QR code, and the uniquely marked vehicle is represented as an ID vehicle; it consists of CPU, motherboard, memory cell, input and output units, SIM card, and GPS system module; the function is to upload the longitude and latitude of ID parking space and those of ID vehicle and receive instructions from the server, and to connect the industrial control unit to open or close the lock of ID vehicle; the ID intelligent lock is connected with the industrial control module to control the opening and closing of the lock of ID vehicle; at the same time, the voice unit receives the instructions from the server, and its industrial control unit plays such instructions in the player; the ID intelligent lock corresponds to the ID vehicle one to one;

It consists of a plurality of passengers' uniquely marked mobile phones, which are represented as ID mobile phones. The ID mobile phone is provided with a SIM card and GPS system modules; ID intelligent lock, ID mobile phone and GPS system communicate with the server through a wired or wireless network; at the departure station, the ID mobile phone scans the ID vehicle to bind the ID mobile phone or the ID vehicle and includes it into the table of ID mobile phones or ID vehicles, and stores the table in the database; at the same time, the server changes the occupied ID sub-parking space of the departure station into the unoccupied ID sub-parking space, and includes it into the unoccupied ID sub-parking space in the table of non-full parking lots; when the passenger arrives at the terminal station, he/she can lock the vehicle directly or scan the QR code of ID parking space, and upload the longitude and latitude of the ID mobile phone or those of the ID vehicle (i.e. the longitude and latitude of ID parking space) to the server, and then the server compares the uploaded longitude and latitude of ID parking space with the table of ID parking spaces and their longitudes and latitudes; only when the longitude and latitude of a certain ID parking space given in the table of ID parking spaces and their longitudes and latitudes correspond to the uploaded longitude and latitude of ID parking space one to one, that is, correspond to the longitude and latitude of ID mobile phone one to one, the ID parking space can be obtained; the server compares the ID parking space with the table of non-full stations; if the ID parking space belongs to a certain non-full ID parking space given in the table of non-full stations, the server will send an instruction to open the gate to the ID mobile phone or the ID intelligent lock; then the ID mobile phone or ID intelligent lock can open the industrial control switch of the ID intelligent lock.

The ID intelligent lock is provided with an industrial control module, which is connected with the lock switch of the ID vehicle to control is. When the ID intelligent lock receives the instruction from the server to open the lock, its industrial control module will control to open the lock of the ID vehicle, and vice versa.

The said intelligent lock database system based on uniquely marked location and longitude and latitude is characterized by: the said intelligent lock includes the mailbox intelligent lock, home intelligent lock, shared bicycle intelligent lock, shared car intelligent lock and parking lot intelligent lock.

The said vehicle includes one of the following items: shared bicycle, shared car and shared electric vehicle.

The said intelligent lock database system based on uniquely marked location and longitude and latitude is characterized by: the longitude and latitude positioning system includes satellite navigation system, mobile phone base station positioning, WIFI positioning, LDAP server and LBS base station location service, and the LBS positioning system for base station positioning has high accuracy (20-200 cm) and no blind zone in the coverage area of mobile phone network; the satellite navigation system includes China's Beidou satellite navigation system BDS, which is referred to as BDS system with high accuracy of civil standard (20-500 cm) and GPS system with civil standard (50-1000 cm).

The said intelligent lock database system based on uniquely marked location and longitude and latitude is characterized by: the wireless network includes mobile network, mobile Internet, WIFI and bluetooth; mobile Internet of Things and mobile network include one of the following: 3G, 4G, 5G and 6G mobile network; the unique mark described below may include QR code.

Definition, establishment, update and function of basic table in the database: including SMS, voice and electronic map unit connected to the mobile APP; basic table is connected to voice unit of the vehicle:

(I) Table of ID gathering stations and their longitudes and latitudes, and table of ID locations and their longitudes and latitudes:

It relates to the establishment of the table of ID gathering stations and their longitudes and latitudes, and table of ID locations and their longitudes and latitudes; the following gathering station includes delivery station, parking lot or station; it is applicable to express delivery box, milk delivery box, shared bicycle, shared car and parking lot; Beidou assistant, Beidou companion positioning system and GPS positioning software can intelligently display the current location. The mode of mobile phone software GPS positioning is to use the GPS positioning module of mobile phone to send its own position signal to the positioning background to achieve mobile phone positioning.

BDS system Beidou assistant, Beidou companion positioning system and GPS positioning system herein are referred to as the GPS system;

(1) Table of ID gathering stations and their longitudes and latitudes (see Table 1): basic table is referred to as the table; the table is stored in the database; the table is connected with the mobile phone electronic map and mainly used for displaying ID gathering stations in the electronic map; the table is connected with the non-full gathering station key. When the key is pressed, all the non-full ID gathering stations are displayed in green in the mobile phone map.

TABLE 1

| Longitude (error 1-50 m) | Latitude (error 1-50 m) | ID gathering station |
|---|---|---|
| East longitude 108.58.7 | North latitude 34.15.20 | East Gate |
| | | gathering station |

Note:
The accuracy of longitude and latitude of the said ID gathering station herein is (1000-2000 cm);

(2) Table of ID locations and their longitudes and latitudes (see Table 2): the location refers to the parking space in terms of shared bicycle, shared car and parking lot, and refers to the mailbox or location in terms of the delivery station system; an ID gathering station is provided with at least one ID location, of which the longitude and latitude can be obtained through a satellite navigation system. All ID locations in the whole area are bound with the longitudes and latitudes of such ID locations one to one and are included in the basic table of ID locations and their longitudes and latitudes, and the table is stored in the database; the table is connected with the mobile phone electronic map and mainly used for displaying ID locations in the electronic map; the table is connected with the non-full ID location key. When the key is pressed, the non-full locations are displayed in green in the mobile phone map.

TABLE 2

| Longitude (error 0.2-10 m) | Latitude (error 0.2-10 m) | ID location |
|---|---|---|
| East longitude | North latitude | The second |
| 108.58.7 | 34.15.20 | location of |
| | | East Gate |
| | | gathering station |

Note:
The accuracy of longitude and latitude of the said ID location herein is (50-1000 cm); that is to say, as long as it conforms to the longitude and latitude of ID parking space, it must conform to the those of ID station;

The production process is as follows: Step 1: at the ID gathering station, the staff measures the longitude and latitude of the ID gathering station, and connects them to GPS system through a wireless network by using BDS locator (with an accuracy of 20-50 cm and military mode is preferred), BDS measuring instrument, GPS locator, GPS measuring instrument or mobile phone GPS positioning module; Step 2: GPS satellite navigation system measures the longitude and latitude of the ID gathering station, and uploads them to the server (positioning background). The server binds the ID gathering station with its longitude and latitude to make the table of ID gathering stations and their longitudes and latitudes, and stores the table in the server database; the server connects the table of ID gathering stations and their longitudes and latitudes to the mobile phone electronic map unit, so that the ID gathering stations and their longitudes and latitudes can be displayed in the mobile phone electronic map;

or a QR code (bar code) of the ID gathering station is generated by a QR code (or bar code) generator and fixed on the ground or erected signboard at the geographical location of such ID gathering station; when the non-full gathering station key on mobile phone is pressed, the non-full gathering stations are displayed in green in the electronic map; Step 3: test whether the ID intelligent lock of the ID gathering station can be opened or closed; Step 4 can be omitted in terms of the express delivery box, milk delivery box, shared bicycle or shared car; Step 4: at the ID location, the staff measures the longitude and latitude of the ID location, and connects them to the satellite navigation system through a wireless network by using BDS locator (with an accuracy of 20-50 cm and military mode is preferred), BDS measuring instrument, GPS locator, GPS measuring instrument or mobile phone GPS positioning module; Step 5: it measures the longitude and latitude of the ID location through the satellite navigation system, and uploads them to the server (positioning background). The server binds the ID location with its longitude and latitude, includes it in the table of ID locations and their longitudes and latitudes, and stores the table in the server database; the server connects the table of ID locations and their longitudes and latitudes to the mobile phone electronic map unit, so that the ID locations and their longitudes and latitudes can be displayed in the mobile phone electronic map; or a QR code (bar code) of the ID location is generated by a QR code (or bar code) generator and fixed on the ground or erected signboard at the geographical location of such ID location; when the non-full location key on mobile phone is pressed, the non-full locations are displayed in green in the electronic map; and the QR code of ID sub-parking space is generated and fixed on the ground or erected signboard of such ID sub-parking space. Step 6: test whether the ID intelligent lock can be opened or closed.

(II) On the establishment, inquiry and update of the table of full gathering stations, and the table of non-full gathering stations:

Gathering stations are divided into non-full gathering stations and full gathering stations; the table of non-full gathering stations, and the table of full gathering stations are stored in the database;

Note: The table of non-full gathering stations and the table of full gathering stations are connected to the “my car location” key of the ID mobile phone APP through the mobile network. In respect of the shared car, if you want to query the location of a certain car, you can press “my car location” and enter the vehicle number (of shared car or shared bicycle), that is, the ID vehicle. The server automatically queries the table of non-full gathering stations and the table of full gathering stations to find out the ID gathering station (station) and ID parking space where the ID vehicle is located, and transmits such information to the ID mobile phone. Its main function is to provide information for private car owners to query their vehicle location.

(1) Table of full gathering stations (assuming that one parking space has two sub-parking spaces) (see Table 3);

When all sub-parking spaces in the parking space are occupied, the parking space will become a full parking space; when all parking spaces in the ID gathering station are full, the ID gathering station will become a full gathering station; and such ID gathering station is included in the table of full gathering stations; Table 3:

| | | The | | | | |
|---|---|---|---|---|---|---|
| | The first | second | | | ID vehicle | ID vehicle |
| | parking | parking | | | bound with | bound with |
| | space | space | | Sub-parking | sub-parking | sub-parking |
| | belonging | belonging | Sub-parking | space counter | space | space |
| Name of | to the full | to the full | space counter | belonging to | counter of | counter of |
| full ID | ID | ID | belonging to | the second | the first | the second |
| gathering | gathering | gathering | the first full | full parking | parking | parking |
| station | station | station | parking space | space | space | space |
| East Gate | Full | Full | Unoccupied | Unoccupied | (1) ID | (1) ID |
| station | | | sub-parking | sub-parking | vehicle | vehicle |
| | | | space = 2 − 2 = 0 | space = 2 − 2 = 0 | number , , , 1 | number , , , 7 |
| | | | | | is occupied; | is occupied; |
| | | | | | (2) ID | (2) ID |
| | | | | | vehicle | vehicle |
| | | | | | number , , , 3 | number , , , 5 |
| | | | | | is occupied | is occupied |

Function of the table of full stations in respect of shared bicycle system: connect the electronic map to display the full station in red in the electronic map to prompt passengers to use the bicycles at the station free of charge, so as to reduce vehicle congestion and improve bicycle turnover rate. When the passenger's mobile phone is bound with the bicycle at this full station, the server will send a short message to the bicycle unit voice prompt or the passenger's mobile phone APP, and notify and send a prompt: (6) “Welcome to use free bicycles!”

(2) Table of non-full gathering stations (assuming that one parking space has two sub-parking spaces) (see Table 4); when at least one sub-parking space in the parking space is unoccupied, the parking space is an non-full parking space; when at least one parking space in the ID gathering station is non-full, the ID gathering station is an non-full gathering station; and such ID gathering station is included in the table of non-full gathering stations; Table 4:

| | | The | | | | |
|---|---|---|---|---|---|---|
| | The first | second | | | ID vehicle | ID vehicle |
| | parking | parking | | | bound with | bound with |
| | space | space | | Sub-parking | sub-parking | sub-parking |
| Name of | belonging | belonging | Sub-parking | space counter | space | space |
| non-full | to the full | to the full | space counter | belonging to | counter of | counter of |
| ID | ID | ID | belonging to | the second | the first | the second |
| gathering | gathering | gathering | the first full | full parking | parking | parking |
| station | station | station | parking space | space | space | space |
| East Gate | Full | Non-full | Unoccupied | Unoccupied | (1) ID | (1) ID |
| station | | | sub-parking | sub-parking | vehicle | vehicle |
| | | | space = 2 − 2 = 0 | space = 2 − 1 = 1 | number , , , 1 | number , , , 7 |
| | | | | | is occupied; | is occupied; |
| | | | | | (2) ID | |
| | | | | | vehicle | |
| | | | | | number , , , 3 | |
| | | | | | is occupied | |

It is mainly used for recording the ID vehicle parked in non-full parking space: when the ID vehicle is parked in non-full parking space, it is deleted from the table of ID mobile phones and ID vehicles and included in the table of non-full ID gathering stations; at the same time, the ID vehicle is bound with a certain unoccupied sub-parking space in the non-full parking space, that is, the sub-parking space changes from the original unoccupied one to the occupied one. The sub-parking space without any parking vehicle is called an unoccupied sub-parking space. The total number of unoccupied sub-parking spaces of non-full ID gathering stations is transmitted to the ID mobile APP and displayed in the electronic map.

(3) On the division of the table of non-full gathering stations: the mode of uniquely numbered sub-parking space adopted by the parking space: the uniquely numbered sub-parking space is represented as an ID sub-parking space (see Table 5); when the ID vehicle is parked in the sub-parking space, such vehicle is bound with the ID sub-parking space; and the unoccupied sub-parking space becomes the occupied one. Table 5:

| | | | | | | ID | | |
|---|---|---|---|---|---|---|---|---|
| | | | | | ID | vehicle | ID | ID |
| | | | | | vehicle | bound | vehicle | vehicle |
| | | | | | bound | with | bound | bound |
| | | | | | with | the | with | with the |
| | | The | | Number of | the first | second | the first | second |
| | The first | second | Number of | sub-parking | sub- | sub- | sub- | sub- |
| | parking | parking | sub-parking | spaces | parking | parking | parking | parking |
| | space | space | spaces | belonging | space | space | space | space of |
| | belonging | belonging | belonging | to the | of the | of the | of the | the |
| Non- | to the | to the | to the first | second | first | first | second | second |
| full ID | non-full | non-full | parking | parking | parking | parking | parking | parking |
| station | ID station | ID station | space | space | space | space | space | space |
| East | Non-full | Non-full | Unoccupied | Unoccupied | [symbol] | [symbol] | [symbol] | (1) ID |
| Gate | | | sub-parking | sub-parking | | | | vehicle |
| station | | | space = 2 − | space = 2 − | | | | number |
| | | | 0 = 2 | 1 = 1 | | | | 63456 is |
| | | | | | | | | occupied; |

[symbol]

indicates data missing or illegible when filed

(4) The counter mode is adopted for sub-parking spaces of a parking space (see Table 6);

Statistics of the total number of parking spaces: a counter is used for counting.

Every time a vehicle is parked, the counter of sub-parking spaces in the parking space is increased by 1. The parking space is provided with a total number of sub-parking spaces. When the number of vehicles (sub-parking spaces) recorded by the counter reaches the total number of sub-parking spaces in the parking space, the parking space is considered as a full parking space; when the number of vehicles (sub-parking spaces) recorded by the counter does not reach the total number of sub-parking spaces, the parking space is considered as an non-full parking space; Table 6:

| | The first | The second | | Sub-parking | ID vehicle | ID vehicle |
|---|---|---|---|---|---|---|
| | parking | parking | Sub-parking | space | bound with | bound with |
| | space | space | space | counter | sub-parking | sub-parking |
| | belonging | belonging | counter | belonging to | space | space |
| | to the non- | to the non- | belonging to | the second | counter of | counter of |
| Non-full ID | full ID | full ID | the first non- | non-full | the first | the second |
| gathering | gathering | gathering | full parking | parking | parking | parking |
| station | station | station | space | space | space | space |
| East Gate | Non-full | Non-full | Unoccupied | Unoccupied | [symbol] | (1) ID |
| station | | | sub-parking | sub-parking | | vehicle |
| | | | space = 2 − 0 = 2 | space = 2 − 1 = 1 | | number |
| | | | | | | 63456 is |
| | | | | | | occupied; |

[symbol]

indicates data missing or illegible when filed

When the last unoccupied sub-parking space of the non-full parking space is occupied, the parking space is considered as a full parking space; otherwise, the full parking space will be deleted from the table of full parking spaces and included in the table of non-full parking spaces;

When the last non-full parking space of the non-full gathering station is occupied, the gathering station is considered as a full gathering station; the non-full gathering station will be deleted from the table of non-full gathering stations and included in the table of full gathering stations; otherwise, the full gathering station will be deleted from the table of full gathering stations and included in the table of non-full gathering stations;

When the uploaded parking space is full, the database system will query the table of non-full parking spaces of the same gathering station in the database, and transmit such non-full parking spaces to the passenger's mobile APP.

(III) On the table of ID parking spaces and their longitudes and latitudes (in shared bicycle and shared car systems) (see Table 2);

The ID mobile phone uploads the longitude and latitude of the ID vehicle or those of the ID mobile phone (ID parking space) to the server for two purposes: (1) it is for ID mobile phone, which obtains an ID vehicle by comparing with the table of ID mobile phones and ID vehicles; (2) it is for the longitude and latitude of the ID mobile phone, which obtains an ID parking space by comparing the longitude and latitude of the ID mobile phone (ID parking space) with the table of ID parking spaces and their longitudes and latitudes. When comparing with the table of non-full ID stations, if the uploaded ID mobile phone (ID parking space) is determined to be a non-full parking space in the table of non-full ID stations, the ID vehicle is bound with the unoccupied ID sub-parking space and stored in the table of non-full stations; at the same time, the binding of the ID vehicle and ID mobile phone is deleted, that is, the ID vehicle and ID mobile phone are deleted from the table of ID mobile phones and ID vehicles; then the parking procedure is completed. If the uploaded ID mobile phone (ID parking space) is determined to be a full parking space, the ID vehicle cannot be bound to the full ID parking space, and it restarts parking in a new parking space until the parking procedure is completed. The function is for ID parking space at the terminal station: (1) the passenger uploads the longitude and latitude of ID vehicle or those of ID mobile phone (i.e. the longitude and latitude of ID parking space at the terminal station) to the server through the GPS module of the ID vehicle or that of the ID mobile phone. The server compares the uploaded longitude and latitude of the ID parking space with the table of ID parking spaces and their longitudes and latitudes to determine whether they belong to a certain ID parking space in the table; (2) determine the ID parking space (i.e. name of parking space) of the uploaded longitude and latitude; the function of ID parking space further includes querying whether the ID parking space belongs to an non-full parking space in the table of non-full stations,

(1) if it belongs to an non-full parking space in the table of non-full stations, an instruction to lock the vehicle will be sent, and the parking procedure is completed; (2) otherwise, no instruction to lock the vehicle will be sent and the passenger cannot lock the vehicle; the passenger re-query the non-full parking spaces in the table of the nearest non-full stations in mobile APP, and parks the vehicle in the non-full parking space given in the table of non-full stations after obtaining such an non-full parking space; (3) if the ID parking space is not non-full, but the ID station where the ID parking space is located belongs to the table of non-full stations, the server will query the non-full parking spaces in the same table of non-full stations in the database, and send out a message or voice prompt to the passenger's mobile phone or vehicle unit to guide the passenger to enter and park in the non-full parking space, so as to complete the purpose of parking the vehicle in an non-full parking space. (4) if the ID parking space is not non-full, and the ID station where the ID parking space is located does not belong to the table of non-full stations, the server will query the non-full station in the table of non-full stations in the database, and the non-full parking spaces in the non-full station, and send out a message or voice prompt to the passenger's mobile phone or vehicle unit to guide the passenger to enter and park in the non-full parking space, so as to complete the purpose of parking the vehicle in an non-full parking space.

(IV) Definition, update and function of non-full parking space in the table of non-full parking spaces (see Table 4): each parking space has a specified number of sub-parking spaces and each sub-parking space has a number. The sum of all sub-parking spaces is the total number of sub-parking spaces; or each parking space has a timer, which is provided with the total number of sub-parking spaces, i.e. the total number of sub-parking spaces in each parking space, including the number of unoccupied sub-parking spaces and that of occupied sub-parking spaces, and the number of unoccupied sub-parking spaces=total number of sub-parking spaces−number of occupied sub-parking spaces;

When the ID vehicle is parked in an unoccupied number of sub-parking space in the sub-parking space belongs to the ID parking space, and it is found that the ID parking space is non-full after querying the non-full parking space in the table of non-full stations (the table is also applicable to the table of non-full parking lots, while replacing “parking space” with “parking lot”), the server will send out an instruction “allow to lock the car” to the ID vehicle or ID mobile phone; the server will send out a short message or voice prompt “4” to the passenger's mobile phone APP or to the ID vehicle; (4) “you have finished locking”

On the non-full parking space in the table of non-full stations:

Note: At the terminal station, when an ID vehicle is parked in an non-full parking space and locked, it is bound with the ID sub-parking space and included in the occupied sub-parking space; the counter of ID parking space is increased by 1, and the parking procedure is completed.

For example, the changes in the table of non-full parking spaces of the parking procedure: at the departure station, when the passenger's ID mobile phone scans the ID vehicle (QR code) in the ID parking space and unlocks it successfully, the ID mobile phone is bound with the ID vehicle and included in the table of ID mobile phones and ID vehicles;

At the same time, the ID vehicle and the occupied sub-parking space are deleted from the table of non-full stations or the table of full stations, that is, the ID vehicle and sub-parking space are deleted; at the same time, the timer in the table of non-full parking spaces or the table of full parking spaces is decreased by 1, and the passenger's bicycling procedure is completed.

For example, the changes in the table of non-full parking spaces of the bicycling procedure:

(1) For the first parking space of East Gate Station in the non-full parking space given in the table of non-full stations, the total number of sub-parking spaces is 3, number of occupied sub-parking spaces is 2 and number of unoccupied sub-parking spaces is 1 before being occupied by the ID vehicle (ID vehicle number 23456) and ID mobile phone; the counter records the total number of unoccupied sub-parking spaces as 1; then the first parking space of East Gate Station in the table of non-full parking spaces is as follows:

Before being occupied by the ID vehicle (ID vehicle number 23456), the first parking space of East Gate Station in the table of non-full parking spaces is as follows:

| | | Name of the | Name of the | Name of the | |
|---|---|---|---|---|---|
| | | first sub- | second sub- | third sub- | |
| | | parking space | parking space | parking space | |
| | | belonging to | belonging to | belonging to | Non-full |
| Non-full | Non-full | the non-full | the non-full | the non-full | parking space |
| station | parking space | parking space | parking space | parking space | counter |
| East Gate | The first | ID vehicle | ID vehicle | Unoccupied | Unoccupied |
| station | parking space | number 23455 | number 23456 | | sub-parking |
| | of East Gate | is occupied | is occupied | | space = 3 − 2 = 1 |
| | Station | | | | |

(2) For the first parking space of East Gate Station in the non-full parking space given in the table of non-full stations, the total number of sub-parking spaces is 3, number of occupied sub-parking spaces is 1 and number of unoccupied sub-parking spaces is 2 after being occupied by the ID vehicle (ID vehicle number 23456) and ID mobile phone; the counter records the total number of unoccupied sub-parking spaces as 1; then the first parking space of East Gate Station in the table of non-full parking spaces is as follows:

| | | Name of the | Name of the | Name of the | |
|---|---|---|---|---|---|
| | | first sub- | second sub- | third sub- | |
| | | parking space | parking space | parking space | |
| | | belonging to | belonging to | belonging to | Non-full |
| Non-full | Non-full | the non-full | the non-full | the non-full | parking space |
| station | parking space | parking space | parking space | parking space | counter |
| East Gate | The first | ID vehicle | Unoccupied | Unoccupied | Unoccupied |
| station | parking space | number 23455 | | | sub-parking |
| | of East Gate | is occupied | | | space = 3 − 2 = 1 |
| | Station | | | | |

On the contrary, for example, the changes in the table of non-full parking spaces of the parking procedure:

(1) For the first parking space of East Gate Station in the table of non-full stations, the total number of sub-parking spaces is 3, number of occupied sub-parking spaces is 1 and number of unoccupied sub-parking spaces is 2 before being occupied by the ID vehicle (ID vehicle number 23456); the counter records the total number of unoccupied sub-parking spaces as 2; then the first parking space of East Gate Station in the table of non-full parking spaces is as shown in Table 4 below:

| | | Name of the | Name of the | Name of the | |
|---|---|---|---|---|---|
| | | first sub- | second sub- | third sub- | |
| | | parking space | parking space | parking space | |
| | | belonging to | belonging to | belonging to | Non-full |
| Non-full | Non-full | the non-full | the non-full | the non-full | parking space |
| station | parking space | parking space | parking space | parking space | counter |
| East Gate | The first | ID vehicle | Unoccupied | Unoccupied | Unoccupied |
| station | parking space | number 23455 | | | sub-parking |
| | of East Gate | is occupied | | | space = 3 − 1 = 2 |
| | Station | | | | |

(2) For the first parking space of East Gate Station in the table of non-full stations, the total number of sub-parking spaces is 3, number of occupied sub-parking spaces is 2 and number of unoccupied sub-parking spaces is 1 after being occupied by the ID vehicle (ID vehicle number 23456); the counter records the total number of unoccupied sub-parking spaces as 1; then the first parking space of East Gate Station in the table of non-full stations is as follows:

Before being occupied by the ID vehicle (ID vehicle number 23456), the first parking space of East Gate Station in the table of non-full stations is as shown in the table below:

| | | Name of the | Name of the | Name of the | |
|---|---|---|---|---|---|
| | | first sub- | second sub- | third sub- | |
| | | parking space | parking space | parking space | |
| | | belonging to | belonging to | belonging to | Non-full |
| Non-full | Non-full | the non-full | the non-full | the non-full | parking space |
| station | parking space | parking space | parking space | parking space | counter |
| East Gate | The first | ID vehicle | ID vehicle | Unoccupied | Unoccupied |
| station | parking space | number 23455 | number 23456 | | sub-parking |
| | of East Gate | is occupied | is occupied | | space = 3 − 2 = 1 |
| | Station | | | | |

(V) Definition and function of the uploaded ID parking space belonging to the full parking space given in the table of non-full stations:

Function of full parking space: when the vehicle is parked in the ID parking space, it queries that the ID parking space belongs to the full parking space in the table of non-full stations, and the server queries the non-full parking space in the table of non-full stations and sends the non-full parking space in the table to the passenger's ID mobile phone or sends a short message or voice prompt “3” to the ID vehicle unit; (3) “the station to which the parking space belongs is a full parking space in the table of non-full stations; please park according to the non-full parking space XXX in the non-full station displayed on your mobile phone! Otherwise, there will be liquidated damages!”

The server sends the instruction of “The vehicle is not allowed to lock” to the ID vehicle or ID mobile phone; the server sends a short message or voice prompt “2” to the passenger's mobile phone APP or to the vehicle unit; (2) “Please press the ‘Non-full Station’ key on the interface, and park the vehicle in the non-full station recommended by the “Non-full Station” on the interface; otherwise, there will be liquidated damages!”

“You don't park your vehicle at an available parking space, please follow the mobile phone short message prompt and park it again in a station with available parking spaces, otherwise there will be liquidated damages, thank you !”,

(VI) Definition and function of uploaded ID parking space belonging to full station or outside the station:

Check whether the uploaded ID parking space is an occupied parking space according to the Table of ID Parking Spaces and Longitude and Latitude of ID Parking Spaces; the ID parking space does not belong to the unoccupied parking spaces in the Table of ID Parking Spaces and Longitude and Latitude of ID Parking Spaces, which indicates that the ID parking space is outside the station;

The server sends a short message or voice prompt “1” to the passenger's mobile phone APP or to the vehicle unit; (1) “You've parked your vehicle in a full station or outside the station, please press the ‘Non-full Station’ key on the interface and park the vehicle in the non-full station recommended by the “Non-full Station” on the interface! Otherwise, there will be liquidated damages!”;

(VII) Definition and function of Table of ID Mobile Phones and ID Parking Lots (see Table 7): When the driver enters the parking lot, the server will bind the ID parking lot, ID vehicle and ID mobile phone and records them in the Table of ID Mobile Phones and ID Parking Lots; when the driver parks at the ID parking space, the server will bind the ID parking space and the occupied sub-parking space and records them in the Table of ID Mobile Phones and ID Parking Lots; meanwhile, when the ID vehicle is bound with an unoccupied sub-parking space in the Table of ID Parking Lots, the sub-parking space will be changed from unoccupied sub-packing space to occupied sub-parking space; when the vehicle leaves from the ID parking space of the parking lot, the server will delete the ID parking lot, ID mobile phone, ID vehicle, ID parking space and occupied sub-parking space from the Table of ID Mobile Phones and ID Parking Lots; the sub-parking space in the Table of Non-full (or Full) Parking Lots is changed from occupied sub-packing space to unoccupied sub-parking space; the parking fee is calculated according to the parking time, which will be included in the bank account of the ID mobile phone and uploaded to the server; the parking fee is transferred to the ID mobile phone APP, and then the procedure is complete. Table 7:

| | | | | First | Second | | | | |
|---|---|---|---|---|---|---|---|---|---|
| | | | ID | sub- | sub- | | | | |
| | | ID | parking | parking | parking | | | Bank | |
| | | vehicle | space | space of | space of | Parking | Leaving | account | |
| ID | ID | (license | of ID | ID | ID | time of | time of | of ID | |
| mobile | parking | plate | parking | parking | parking | ID | ID | mobile | Parking |
| phone | lot | number) | lot | space | space | vehicle | vehicle | phone | fee |
| , , , | , , , | , , , | , , , | , , , | , , , | , , , | , , , | , , , | , , , |

(VIII) Definition and function of Table of Passenger ID Vehicles and ID Mobile Phones (see Table 8): At the departure station, when the passenger ID mobile phone scans and unlocks the ID vehicle parked in the station, the server will bind the passenger ID mobile phone with the ID vehicle parked in the station and record it in the Table of Passenger ID Vehicles and ID Mobile Phones;

meanwhile, when the sub-parking space is deleted from the occupied sub-parking spaces in the Table of Non-full (or Full) Stations, the sub-parking space will be changed from occupied sub-parking space to unoccupied sub-parking space; when the ID vehicle arrives at the ID parking space of the station, the server will delete the ID mobile phone and ID vehicle from the Table of ID Mobile Phones and ID Vehicles; the sub-parking space in the Table of Non-full Stations is changed from unoccupied sub-parking space to occupied sub-parking space; the parking fee is calculated according to the parking time or distance, which is included in the bank account of the ID mobile phone and uploaded to the server; the server transfers the cycling fee to the ID mobile APP, and then the procedure is complete.

Table 8:

| | | | | First sub- | | | ID | First sub- | | | |
|---|---|---|---|---|---|---|---|---|---|---|---|
| | | | ID | parking | | | parking | parking | Time | | |
| | | | parking | space of | | | space of | space of | to | | |
| | | | space of | ID | Time | ID | ID | ID | arrive | Bank | |
| | | ID | ID | parking | to start | station | station | parking | at | account | |
| ID | | station of | station of | space of | cycling | of | of | space of | station | of ID | |
| mobile | ID | departure | departure | departure | of ID | terminal | terminal | terminal | of ID | mobile | Parking |
| phone | vehicle | station | station | station | vehicle | station | station | station | vehicle | phone | fee |
| [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

(IX) Definition and function of Table of ID Vehicles and Second Passenger ID Mobile Phones: When parking the vehicle outside the station, the passenger will be unable to lock the vehicle directly, and the ID intelligent lock will give a voice prompt (10) “You've parked the vehicle outside the station, please press the ‘Emergency Key’ to lock the vehicle”, then the passenger presses the “Emergency Key” on the ID mobile phone, the ID mobile phone or ID intelligent lock will upload the “Request for emergency vehicle locking” to the server, and the server will send the instruction of “Vehicle locking permitted” to the ID mobile phone or ID intelligent lock only after receiving the “Request for emergency vehicle locking” from the ID mobile phone or ID intelligent lock; when the ID intelligent lock is open, the first passenger will directly lock the ID vehicle at a location outside the station which is referred to as the second departure station for short; the ID vehicle intelligent lock or ID mobile phone uploads the parking longitude and latitude to the server, and the server binds the ID vehicle with the longitude and latitude of the location outside the station and includes it in the Table of ID Vehicles and Longitude and Latitude of Locations Outside Station (see Table 9) which is stored in the database; meanwhile, the passenger becomes the first passenger and the liquidated damages is deducted from the first passenger; the subsequent passenger returns the vehicle, and the subsequent passenger is called the second passenger; staff is provided or the second passenger inquires to return the vehicle; the binding of the passenger ID mobile phone and the ID vehicle is not released; the server converts the Table of ID Mobile Phones and ID Vehicles of the (first) passenger into the Table of ID Vehicles and Second Passenger ID Mobile Phones in the database; see Table 10 below:

| | | | | Time to | Time to | | | | Overdue | | | Time to | Time to | | |
|---|---|---|---|---|---|---|---|---|---|---|---|---|---|---|---|
| | ID | | First | start | lock | | | | fine in | Sec- | Second | start | lock | | |
| | first | First | pas- | cycling | vehicle | | | | first | ond | pas- | cycling | vehicle | | Bonus in |
| | de- | pas- | senger | of first | of first | | ID | | passen- | pas- | senger | of second | of second | Ter- | second |
| ID | par- | senger | ID | passen- | passen- | | second | Wait- | ger ID | senger | ID | passenger | passenger | min- | passenger |
| ve- | ture | ID | mobile | ge rID | ger ID | Park- | depart- | ing | mobile | ID | mobile | ID | ID | al | ID mobile |
| hi- | sta- | mobile | phone | mobile | mobile | ing | ure | time | phone | mobile | phone | mobile | mobile | sta- | phone |
| cle | tion | phone | account | phone | phone | fee | station | timer | account | phone | account | phone | phone | tion | account |
| , , , | , , , | , , , | , , , | , , , | , , , | , , , | , , , | , , , | , , , | , , , | , , , | , , , | , , , | , , , | , , , |

Waiting time=the time when the first passenger ID mobile phone locks the vehicle to the time when the second passenger ID mobile phone unlocks the vehicle; the basic table is provided with a waiting time timer, and the waiting time is calculated as: waiting time=the waiting time timer starts counting when the first passenger ID mobile phone locks the vehicle and ends counting when the second passenger ID mobile phone unlocks the vehicle; waiting fee=waiting time*waiting rate (to be specified by the enterprise); when the second passenger ID mobile phone scans and unlocks the ID vehicle parked outside the station, the second passenger ID mobile phone is bound with the vehicle parked outside the station and included in the Table of ID Vehicles and Second Passenger ID Mobile Phones; it confirms that the second passenger ID mobile phone starts to use the ID vehicle parked outside the station, starts counting the time of using the ID vehicle and establishes the second passenger ID mobile phone account in which bonus will be included when the vehicle arrives at the terminal station;

At the second departure station, it confirms that the second passenger ID mobile phone starts to use the ID vehicle, starts to calculate the time of using the ID vehicle and establishes the second passenger ID mobile phone account connection; and at the terminal station, the vehicle using fee is calculated according to the time or distance of using the second passenger ID vehicle and included in the second passenger ID mobile phone account; the vehicle using fee is calculated as follows: the first passenger: expenditure of the first passenger's account=vehicle using fee of the first passenger+overdue fine+waiting fee; the second passenger: expenditure of the second passengers account=vehicle using fee of the second passenger−bonus−waiting fee.

(X) Definition and function of Table of ID Vehicles and Longitude and Latitude of Locations Outside Station (see Table 9): There are two situations where the passenger parks the ID vehicle outside the station, (1) when the vehicle is outside the station and it is impossible to directly lock the vehicle manually, for which the passenger presses the “Emergency Key” in the mobile APP, the “Emergency Key” uploads the “Emergency stop” request to the server, the server instructs the vehicle intelligent lock to permit the vehicle to be locked, the passenger directly locks the vehicle manually, and the ID vehicle intelligent lock or ID mobile phone uploads the longitude and latitude of the location outside station to the server, the ID vehicle is considered as parked outside the station; (2) when the vehicle is parked at an occupied parking space against the established procedures for more than a certain specified time which is set to be 20-30 minutes, the ID vehicle is considered as parked outside the station;

The server binds the ID vehicle with the longitude and latitude of the location outside the station and include it in the Table of ID Vehicles and Longitude and Latitude of Locations Outside Station; the server connects the table to the mobile phone electronic map; if the ID vehicle is not parked at the station, it will display black in the mobile phone electronic map, (when the second passenger scans the vehicle and starts cycling, the black of the vehicle displayed in the electronic map will be deleted.)

The ID location outside the station is called the uniquely marked parking space of the second departure station, which is expressed as parking space of second departure station; see Table 9;

| | | | |
|---|---|---|---|
| | | Parking space | ID vehicle |
| | | of ID second | not parked |
| Longitude | Latitude | departure station | in station |

| | | |
|---|---|---|
| East longitude | North latitude | , , , |
| 108.58.7 | 34.15.20 | |

Note:
(A) When the longitude and latitude of ID vehicle uploaded by the ID vehicle is not the longitude and latitude of ID parking space in the Table of ID Parking Spaces and Longitude and Latitude of ID Parking Spaces, or the station is a full station, a short message of “Vehicle locking is not completed, please park the vehicle at the nearest station, otherwise there will be liquidated damages” will be sent to the ID mobile phone, and then the whole procedure is completed, subject to the short message sent by the server.
(B) When the second passenger ID mobile phone is bound to the ID vehicle, the server will send a short message to the ID vehicle unit for voice prompt or to the passenger's mobile phone APP for notification prompt. (7) “Welcome to use the bonus-gaining vehicle!”

### BRIEF DESCRIPTION OF DRAWINGS

FIG. 1 is the physical structure diagram of an intelligent lock database system with uniquely marked delivery station and longitude and latitude:

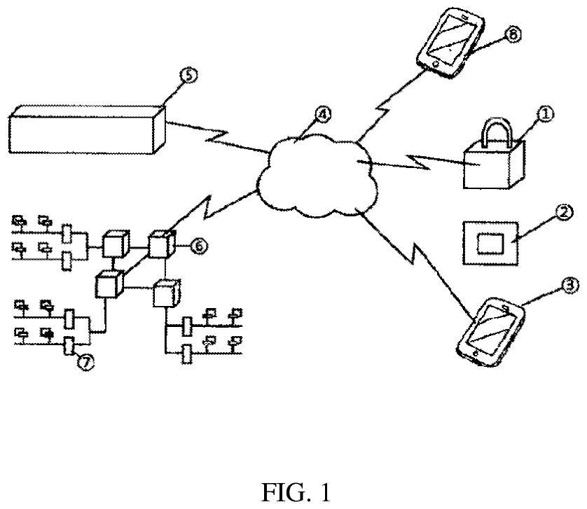

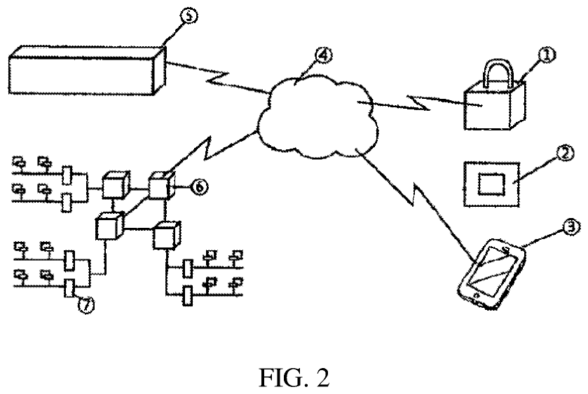

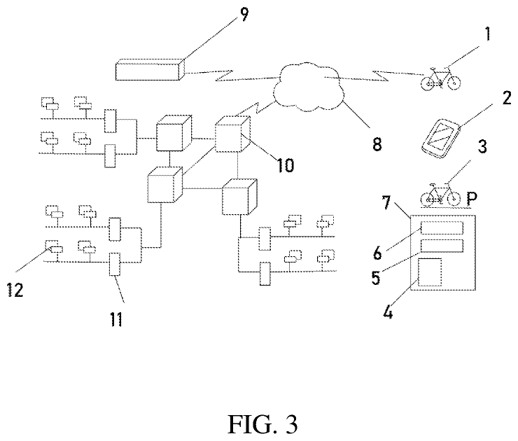

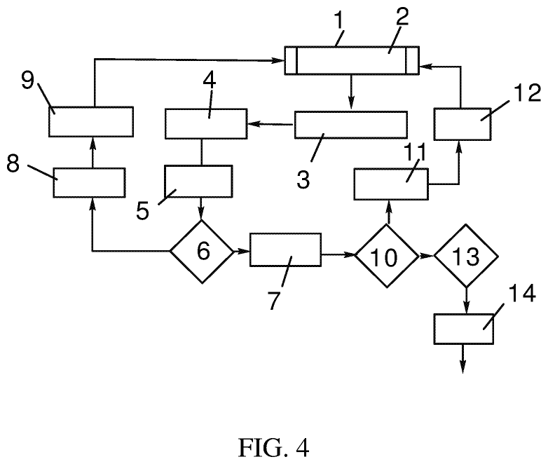

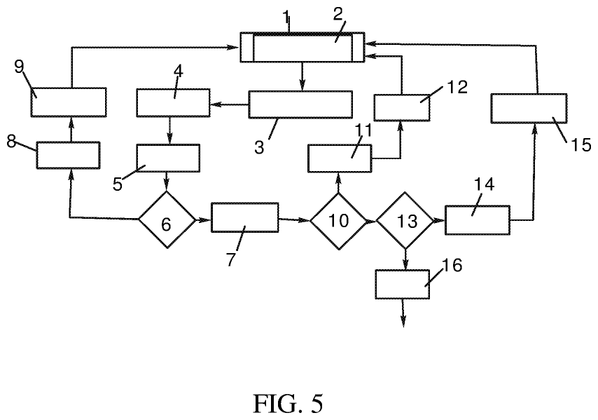

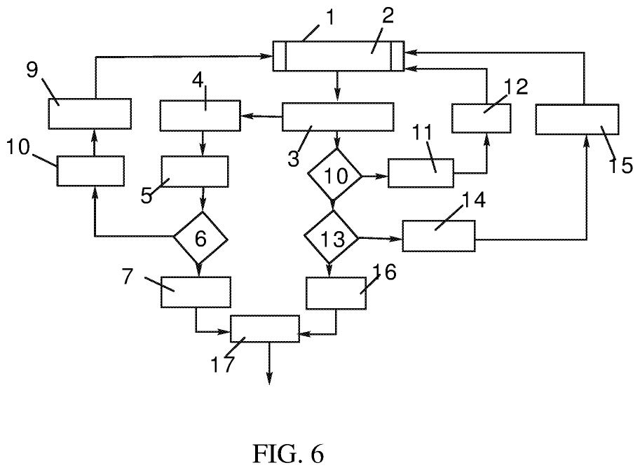

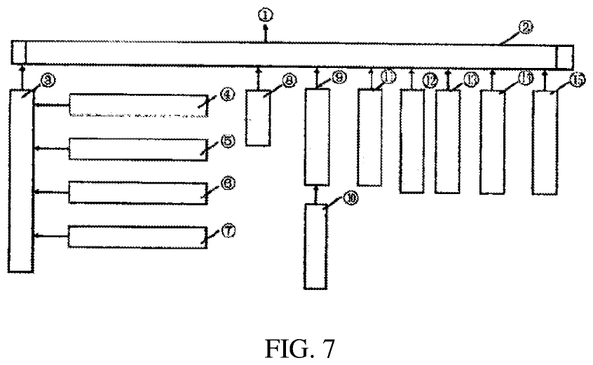

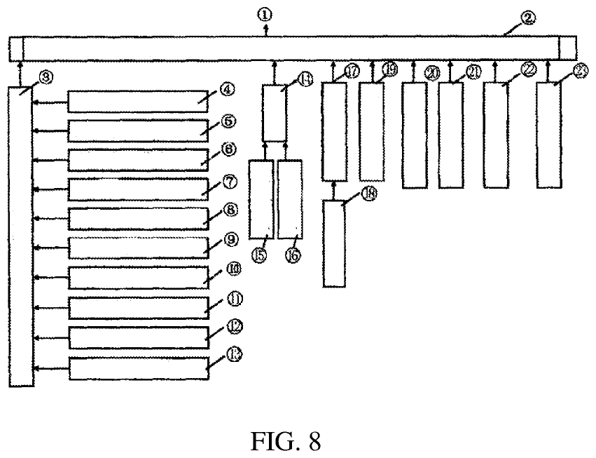

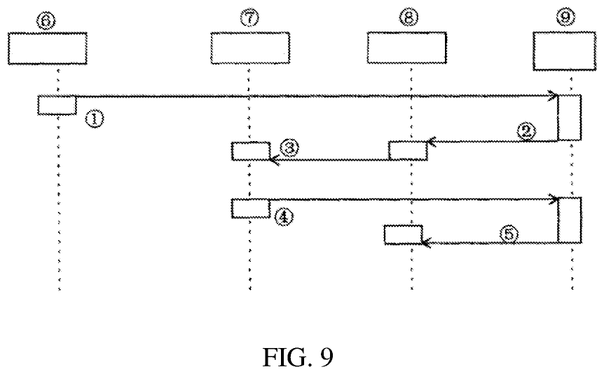

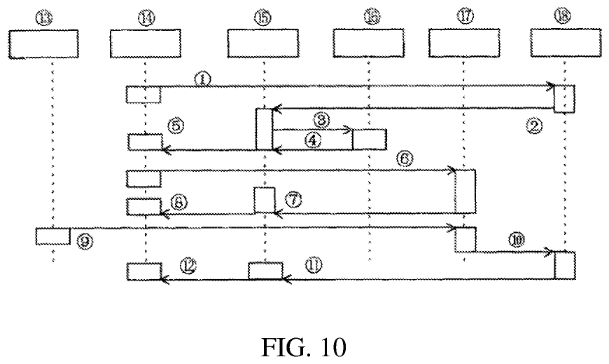

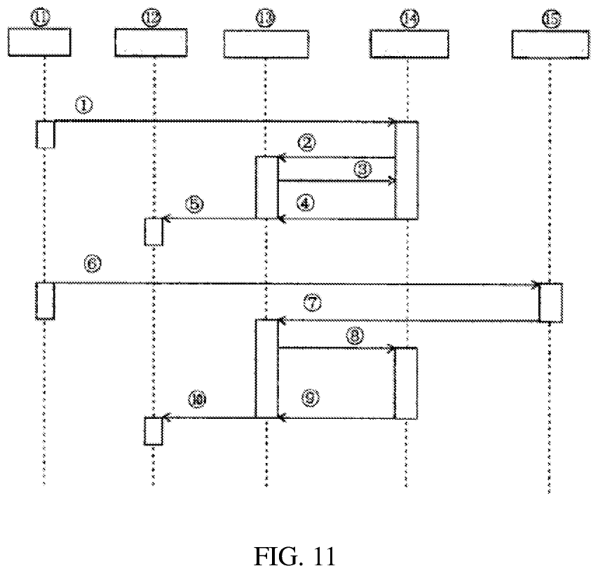

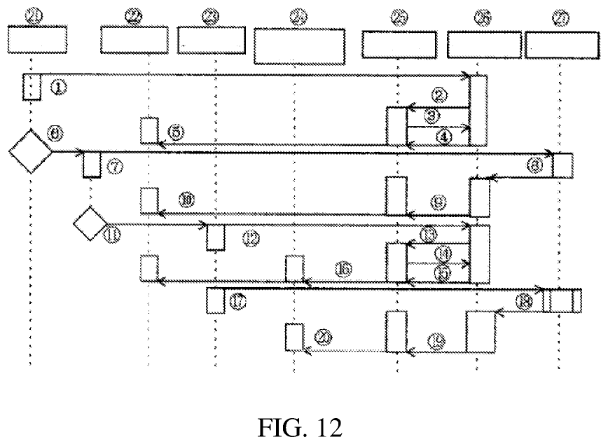

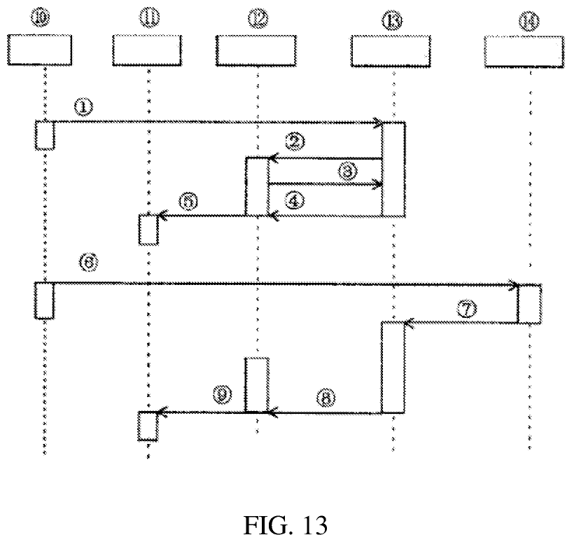

The gathering station includes express delivery stations and milk delivery stations:

1 is the ID delivery station provided with an ID delivery station computer which is connected with the ID sub-intelligent lock;

2 is ID the delivery station, as well as the longitude and latitude, ID location (including QR code) and ID sub-location of the ID delivery station; as well as the longitude and latitude of the ID delivery station, including the longitude and latitude of the ID location;

3 is the staffs mobile phone; 4 is the wireless network; 5 is the longitude and latitude positioning system and GPS positioning system; 6 is the Internet and 7 is the server; 8 is the customer's ID mobile phone.

FIG. 2 is the physical structure diagram of an intelligent lock database system with uniquely marked parking lot and longitude and latitude:

1 is the ID parking lot computer, or ID intelligent lock; the ID parking lot computer contains the gate switch, inbound unit license plate recognition system, outbound unit license plate recognition system, industrial control module connected with access gate, control gate switch, access gate, and access gate connected with fence to form a closed ID parking lot; the function of the ID parking lot computer is to receive instructions from the server, transmit the instructions to the computer access gate intelligent lock of the ID parking lot, upload real-time data to the server: the server or ID parking lot computer binds the ID mobile phone, ID parking lot and ID vehicle and includes them in the Table of ID Mobile Phones and ID Parking Lots; the calculation of the parking time of the vehicle and the parking fee of the passenger's mobile phone account is carried out by the server or the ID parking lot computer; the server contains instruction computer programs which store the Table of ID Mobile Phones and ID Parking Lots, Table of ID Parking Lots and Longitude and Latitude of Parking Lots, Table of Non-full ID Parking Lots, Table of Counters of Non-full ID Parking Lots and Table of Full ID Parking Lots; the short message prompt subsystem of the server is connected with the parking lot voice prompt system or ID mobile phone electronic map and voice unit prompt through mobile network.

That is, the Table of ID Mobile Phones, ID Parking Lots and ID Vehicles are in the parking lot computer, and the server or parking lot computer completes the timing and billing of the vehicle; the server includes the above data of the ID parking lot into the Table of ID Non-full Parking Lots, Table of ID Full Parking Lots and the number of unoccupied parking spaces of the database to facilitate the timely maintenance of the parking lot and reduce the load of the server; the server is connected with the electronic map of the mobile APP, and the non-full parking lot is connected with the Table of ID Non-full Parking Lots, which is displayed in green; the full parking lot is connected with the Table of ID Full Parking Lots, which is displayed in red; 2 is the ID parking lots (including QR code) and the longitude and latitude of ID parking lots of the whole area; further including ID parking spaces and longitude and latitude of ID parking spaces; 3 is the driver ID mobile phone; 4 is the wireless network; 5 is the longitude and latitude location positioning system and GPS positioning system; 6 is the server.

FIG. 3 is the physical structure diagram of an intelligent lock database system with uniquely marked station and longitude and latitude: 1 is the ID vehicle unit (the vehicle includes shared car and shared bicycle), containing the ID vehicle and ID intelligent lock; the ID intelligent lock contains (A) vehicle lock switch industrial control module: vehicle lock and vehicle lock industrial control module; the main function of the ID intelligent lock is to accept instructions from the server and control the opening and closing of the vehicle lock; (B) voice prompt industrial control module: the voice prompt module of the server transmits voice prompt instructions to the ID intelligent lock and the voice prompt industrial control module of the ID vehicle connected with the ID intelligent lock, the voice prompt industrial control module controls the voice player (speaker) to send 2-7 voice prompts; the voice prompt unit and vehicle unit intelligent lock is connected with the short message prompt subsystem of the server; the function of the short message prompt subsystem of the server is to send voice prompts to the vehicle unit intelligent lock voice prompt, or send short messages or voice prompts to the passenger's mobile phone APP short message and mobile phone APP voice prompt; the voice prompt industrial control module of the intelligent lock voice prompt unit controls 2-7 voice prompt keys to prompt: (1) “You don't park the vehicle at the specified station, please press the ‘Non-full Station’ key on the interface and park the vehicle in the non-full station recommended by the ‘Non-full Station’ on the interface! Otherwise, there will be liquidated damages!”; (1) “Please press the ‘Non-full Station’ key on the interface and park the vehicle in the non-full station recommended by the ‘Non-full Station’ on the interface! Otherwise, there will be liquidated damages!”; (2) “Please press the ‘Non-full Station’ key on the interface and park the vehicle in the non-full station recommended by the ‘Non-full Station’ on the interface; otherwise, there will be liquidated damages!” (3) “The station to which the parking space belongs is a full parking space in the Table of Full Stations; please park the vehicle at the XXX parking space of the unoccupied parking space in the non-full station displayed on the mobile phone! Otherwise, there will be liquidated damages!” (4) “You have completed locking” (5) “You've parked the vehicle in a full station, please press the ‘Non-full Station’ key on the interface and park the vehicle in the non-full station recommended by the ‘Non-full Station’ on the interface; otherwise, there will be liquidated damages!”. (6) “Welcome to use the free vehicle!” (7) “Welcome to use the bonus-gaining vehicle!”

2 is the passenger's ID mobile phone APP; 3 is the station unit, or parking space unit, hereinafter referred to as the parking space unit; 4 is the name of the sub-parking space (sorted by Arabic numerals); 5 is the ID parking space (may contain QR code), and the longitude and latitude of the ID parking space; 6 is the longitude and latitude of the ID station (may contain QR code); 6 is the name of the station; 7 is the station marking unit which is written on the ground or erected plate; 8 is the wireless network; 9 is the longitude and latitude positioning system and GPS positioning system; 10 is the Internet; 11 is a server, containing instruction (algorithm) computer programs; 12 is the timer; the server is connected with a timer which will stop issuing the “Locking permitted” instruction after a specified time period, with the purpose to make the passenger to lock the vehicle within a limited time; the limited time can be 5 s to 60 s.

FIG. 4 is the instruction (algorithm) computer program flow chart of an intelligent lock database system with uniquely marked parking lot and longitude and latitude; the function is that the server sends instructions to open and close the intelligent lock of the ID parking lot to the ID vehicle and ID mobile phone after comparing the longitude and latitude of the ID parking lot uploaded by the ID vehicle and ID mobile phone with the Table of ID Parking Lots and Longitude and Latitude of ID Parking Lots (see Table 1) and Table of Non-full Packing Lots (see Table 4) so as to make the vehicle parked in a non-full parking lot: 1 is the server; 2 is the server ID parking lot intelligent lock instruction subsystem; 3 is that the driver uses the ID mobile phone to press the “Enter Parking Lot” key or scan the parking lot mark (QR code) at the access gate of the parking lot to start the procedure of application to enter the parking lot; 4 is the mobile phone's GPS positioning module, through which the longitude and latitude of the ID mobile phone, i.e. the ID parking lot, can be obtained;

5 is that the GPS system obtains the longitude and latitude of the ID parking lot, i.e. the longitude and latitude of the ID mobile phone, and uploads it to the server; 6 is that the server compares the uploaded longitude and latitude of ID parking lot with the Table of ID Parking Lots and Longitude and Latitude of ID Parking Lots (see Table 1); 7 is that the uploaded longitude and latitude of ID parking lot complies with the Table of ID Parking

Lots and Longitude and Latitude of ID Parking Lots, and the server sends the unlocking instruction to the parking lot gate intelligent lock to obtain the ID parking lot, and sends the unlocking permission instruction to the ID mobile phone or the ID parking lot gate intelligent lock; 8 is that the uploaded longitude and latitude of ID parking lot does not comply with the Table of ID Parking Lots and Longitude and Latitude of ID Parking Lots, and the server does not send the instruction to open the intelligent lock of the parking lot gate;

9 is that the server sends a short message voice prompt to the ID mobile phone to give a notice prompt: (1) “Please press the ‘Nearest Parking Lot’ key on the interface and park the vehicle at the nearest non-full parking lot recommended by the ‘Nearest Parking Lot’ on the interface!”; the passenger scans a parking space of the nearest non-full parking lot again according to the prompt and park the ID vehicle in the non-full parking lot; 10 is to compare the ID parking lot with the Table of Non-full Parking Lots (see Table 4); 11 is that the ID parking lot is a full parking lot, and no vehicle locking instruction is sent; 12 is that the server sends a short message to the ID mobile phone or ID mobile phone voice prompt to give a notice prompt: (2) “Please press the ‘Non-full Parking Lot’ key on the interface and park the vehicle in the non-full station recommended by the ‘Non-full Parking Lot’ on the interface; otherwise, there will be liquidated damages!”; 13 is that the uploaded ID parking lot complies with the Table of Non-full Parking Lots, the server sends a short message to the parking lot gate intelligent lock voice prompt or the passenger's ID mobile phone voice prompt to give a notice prompt (4) “Parking allowed”; 14 is that the ID mobile phone scans a parking space of the non-full ID parking space and uploads the ID parking space to the server; the server include the ID parking space into the Table of ID Mobile Phones and ID Parking Lots (see Table 7)

FIG. 5 is the instruction (algorithm) computer program flow chart of an intelligent lock database system with uniquely marked station and longitude and latitude; the method is that the vehicle must be parked at the specified parking space, and when the vehicle is parked at the specified parking space, the server will send the locking instruction, otherwise, the server will not sent the vehicle locking instruction; the function is that the server sends instructions to open and close the intelligent lock of the ID vehicle after comparing the longitude and latitude of ID parking space uploaded by the ID vehicle and ID mobile phone with the Table of ID Parking Spaces and Longitude and Latitude of Parking Spaces (see Table 2) and Table of Non-full Stations (see Table 4), so as to make the vehicle parked at an unoccupied parking space:

1 is the server; 2 is the server ID vehicle intelligent lock instruction subsystem; 3 is that the driver ID mobile phone presses the Vehicle Parking key or scans the ID parking space (QR code) at the ID parking space to start the procedure of application for parking; 4 is to obtain the longitude and latitude of the ID mobile phone, i.e. the ID parking space, through the GPS positioning module of the GPS system of the mobile phone; 5 is to obtain the longitude and latitude of the ID parking space, i.e. the longitude and latitude of the ID mobile phone, through the GPS system, and upload it to the server; 6 is that the server compares the uploaded longitude and latitude of ID parking space with the Table of ID Parking Spaces and Longitude and Latitude of ID Parking Spaces (see Table 2); 7 is that the uploaded longitude and latitude of ID parking space complies with some ID parking space in the Table of ID Parking Spaces and Longitude and Latitude of ID Parking Spaces, the server sends an unlocking instruction to the ID intelligent lock, indicating that the ID vehicle is parked at the specified ID parking space, to obtain the ID parking space, and sends an unlocking permission instruction to the ID mobile phone or ID intelligent lock; 8 is that the uploaded longitude and latitude of ID parking space does not comply with the Table of ID Parking Spaces and Longitude and Latitude of ID Parking Spaces, and the server does not send the unlocking instruction; 9 is that the server sends a short message voice prompt to the ID mobile phone to give a notice prompt: (1) “You don't park the vehicle at the specified station, please press the ‘Nearest Parking Space’ key on the interface and park the vehicle at the nearest unoccupied parking space recommended by the ‘Nearest Parking Space’ on the interface!”; the passenger scans the nearest unoccupied parking space again and park the vehicle according to the prompt, and then the ID vehicle is parked at the unoccupied ID parking space;

10 is to compare the ID parking space with the “Table of Non-full Stations” (see Table 4); 11 is that the station to which the parking space belongs is a full station, and no vehicle locking instruction is sent; 12 is that the server sends a short message to the vehicle unit voice prompt or the passenger's mobile phone APP voice prompt to give a notice prompt: (2) “Please press the ‘Non-full Station’ key on the interface, and park the vehicle in the non-full station recommended by the “Non-full Station” on the interface; otherwise, there will be liquidated damages!”, scan the parking space mark of the unoccupied parking space and upload the parking space mark to the server; the passenger cycles to the parking space mark after parking the vehicle at the unoccupied parking space to confirm the sub-procedure;

13 is that the station to which the ID parking space belongs is a non-full station and unoccupied parking spaces are compared; 14 is that the uploaded ID parking space is not an unoccupied parking space, no vehicle locking instruction is sent, and unoccupied parking spaces in the same station are checked; unoccupied parking spaces in the Table of Non-full Stations are found out; 15 is to transmit the ID parking space of the unoccupied parking space in the non-full station to the ID mobile phone through short message; the server sends a short message to the vehicle unit voice prompt or the passenger's ID mobile phone voice prompt to give a notice prompt (3) “The station to which the parking space belongs is an occupied parking space in the Table of Non-full Stations; please park the vehicle at the XXX parking space of the unoccupied parking space in the non-full station displayed on the mobile phone! Otherwise, there will be liquidated damages!”; the passenger scans the ID parking space of the unoccupied parking space again according to the short message prompt and park the ID vehicle at the ID parking space of the unoccupied parking space; 16 is that the uploaded ID parking space complies with the Table of Unoccupied Parking Spaces, and the vehicle locking permission instruction is sent; the server sends a short message to the ID vehicle unit voice prompt or the passenger's mobile phone APP voice prompt to give a notice prompt: (4) “You have completed locking”

Note: When the passenger parks the vehicle outside the station, the server will send a short message to the vehicle unit voice prompt or the passenger's ID mobile phone voice prompt: (5) “You've parked the vehicle in a full station, please press the ‘Non-full Station’ key on the interface and park the vehicle in the non-full station recommended by the ‘Non-full Station’ on the interface; otherwise, there will be liquidated damages!”.

FIG. 6 is the flow chart of the instruction (algorithm) computer program of an intelligent lock database system (mobile phone scanning ID parking space marking (QR code) mode) with uniquely marked station and longitude and latitude and the instruction (algorithm) computer program of an intelligent lock database system with uniquely marked parking lot and longitude and latitude; the function is that the server sends instructions to open and close the ID vehicle intelligent lock to the ID vehicle and ID mobile phone after comparing the longitude and latitude of the ID parking space uploaded by the ID vehicle and ID mobile phone with the Table of ID Parking Spaces and Longitude and Latitude of ID Parking Spaces and Table of Non-full Stations so as to make the vehicle parked at an unoccupied parking space: (applicable to shared bicycle, shared car and parking lot); flow chart: 1 is the server; 2 is the server ID vehicle intelligent lock instruction subsystem; 3 is that the passenger uses the ID mobile phone to scan the ID parking space mark and apply to confirm that the parking space mark is legal; 4 is that the GPS positioning module of the ID mobile phone contacts with the satellite navigation system to identify the longitude and latitude of the ID mobile phone, i.e. the longitude and latitude of the ID parking space; 5 is that the satellite navigation system obtains the longitude and latitude of the ID mobile phone and uploads them to the server; 6 is that the server compares the longitude and latitude of the ID parking space with the Table of ID Parking Space and Longitude and Latitude of ID Parking Spaces (see Table 2); 7 is that the uploaded longitude and latitude of ID parking space complies with the Table of ID Parking Spaces and Longitude and Latitude of ID Parking Spaces, and the vehicle locking instruction is sent; 8 is that the uploaded longitude and latitude of ID parking space does not comply with the Table of ID Parking Spaces and Longitude and Latitude of ID Parking Spaces, and no vehicle locking instruction is sent; 9 is that the server sends a short message to the passenger's ID mobile phone, ID vehicle voice prompt or passenger's ID mobile phone voice prompt to give a notice prompt: (1) “Please press the ‘Non-full Station’ key on the interface, and park the vehicle in the non-full station recommended by the “Non-full Station” on the interface! Otherwise, there will be liquidated damages!”; the passenger scans the parking space mark of an unoccupied parking space again according to the prompt and parks the ID vehicle at the unoccupied parking space; 10 is to compare the ID parking space with the Table of Non-full Stations (see Table 3) after confirming the ID parking space (i.e. the name of the ID parking space) according to the Table of ID Parking Spaces and Longitude and Latitude of ID Parking Spaces; 11 is that the station to which the parking space belongs is a full station, and no vehicle locking instruction is sent; 12 is that the server sends a short message to the passenger's ID mobile phone voice prompt, ID vehicle voice prompt or passenger's mobile phone APP voice prompt: (1) “Please press the ‘Non-full Station’ key on the interface, and park the vehicle in the non-full station recommended by the “Non-full Station” on the interface! Otherwise, there will be liquidated damages!“; the passenger scans the parking space mark of an unoccupied parking space again according to the prompt and parks the ID vehicle at the unoccupied parking space; 13 is that the station to which the parking space belongs is an unoccupied parking space in the Table of Non-full Stations; 14 is that the uploaded ID parking space mark does not comply with unoccupied parking space, no vehicle locking instruction is sent, and unoccupied parking spaces in the station are further checked; the station to which the parking space is an unoccupied parking space in the Table of Non-full Stations; 15 is to transmit the code of the unoccupied ID parking space in the non-full station to the server; the server sends a short message to the passenger's ID mobile phone voice prompt, ID vehicle voice prompt or passenger's ID mobile phone voice prompt to give a notice prompt (3) “The station to which the parking space belongs is an occupied parking space in the Table of Non-full Stations; please park the vehicle at the XXX parking space of the unoccupied parking space in the non-full station displayed on the mobile phone! Otherwise, there will be liquidated damages!”; the passenger scans the parking space mark of an unoccupied parking space again according to the prompt and parks the ID vehicle at the unoccupied parking space;

16 is that the uploaded ID parking space mark matches an unoccupied parking space in the Table of Non-full Stations, and the vehicle locking instruction is sent; 17 is that the uploaded longitude and latitude of ID parking space complies with the Table of ID Parking Spaces and Longitude and Latitude of ID Parking Spaces, meanwhile, when the uploaded ID parking space mark complies with the unoccupied parking space in the Table of Non-full Stations, the vehicle locking instruction will be sent, otherwise, if one of them does not conform to the regulations, the vehicle locking instruction will not be sent, or the sent vehicle locking instruction will be withdrawn; at the same time, the server sends a short message to the passenger's mobile phone APP, vehicle unit voice prompt or passenger's mobile phone APP voice prompt to give a notice prompt: (4) “You've completed locking”

FIG. 7 is the illustration diagram of the ID mobile phone APP interface subsystem of an intelligent lock database system with uniquely marked parking lot and longitude and latitude (applicable to the parking lot):

1 is that the corresponding module of the ID mobile phone APP is connected with the corresponding module of the server through mobile network; 2 is the front end (interface) of the ID mobile phone APP, when the driver opens the front end (homepage interface) of the ID mobile phone APP, the query directory will be displayed; 3 is the operation bar of the query directory, which displays the operation keys of function query 4-7; 4 is the Nearest Non-full Parking Lot key, pressing this key will display the total number of non-full parking lots and unoccupied sub-parking spaces around the driver's location, as well as location marks of full parking lots; the ID mobile phone APP or electronic map is connected with the Table of Non-full Parking Lots and Table of Full Parking Lots of the database; non-full parking lot is displayed in green and full parking lot is displayed in red in the electronic map; there are also navigation keys, with which the driver can select one of the ID parking lots to enter the navigation system which will guide the driver to the nearest non-full parking lot; 5 is the Nearest Unoccupied Parking Space key, after entering the non-full station, pressing this key will display unoccupied parking spaces and occupied parking spaces around the driver's location; the ID mobile phone APP or electronic map is connected with unoccupied parking spaces and occupied parking spaces in non-full parking lots of the database; unoccupied parking space is displayed in green and occupied parking space is displayed in red in the electronic map; 6 is to enter the parking lot, (1) after entering the parking lot, the driver uses the scanner in the ID mobile phone to scan the ID parking lot (containing QR code) at the entrance of the parking lot, presses this key to start the ID mobile phone GPS module and obtain the longitude and latitude of the ID mobile phone, i.e. the longitude and latitude of the ID parking lot, through the satellite navigation system, and uploads them to the server; the server compares the longitude and latitude of the ID mobile phone with the Table of ID Parking Lots and Longitude and Latitude of ID Parking Lots (see Table 1); if the uploaded longitude and latitude of ID mobile phone belongs to the Table of ID Parking Lots and Longitude and Latitude of ID Parking Lots and the parking lot is a non-full parking lot, the server will agree the vehicle to enter the parking lot; the license plate recorder at the access gate records the license plate number of the ID vehicle, binds the license plate number of the ID vehicle with the ID parking lot, and includes it into the Table of ID Parking Lots and License Plate Number of ID Vehicles; (2) or when reaching the ID parking space, the driver uses the scanner in the ID mobile phone to scan the ID parking space mark (containing QR code), presses this key to start the ID mobile phone GPS module and obtain the longitude and latitude of the ID mobile phone, i.e. the longitude and latitude of the ID parking space, through the satellite navigation system, and uploads them to the server; the server compares the longitude and latitude of the ID mobile phone with the Table of ID Parking Spaces and Longitude and Latitude of ID Parking Spaces; if the uploaded longitude and latitude of ID mobile phone belongs to the Table of ID Parking Spaces and Longitude and Latitude of ID Parking Spaces and the parking space is an unoccupied parking space, the server will agree to use the parking space, bind the ID parking space with the ID mobile phone and include it in the Table of ID Parking Spaces Bound with ID Mobile Phones; 7 is the Account Query key, with which the passenger's account can be inquired; the mobile phone APP is provided with a bank payment module which contains the mobile APP bound with bank payment account, including third party payment accounts, such as Alipay and WeChat Payment Account, and is connected with the Table of Passenger's Accounts of the server; 8 is the scanning reader, with which the driver can use the ID mobile phone to scan the ID parking lot mark to start the GPS module of the ID mobile phone and obtain the longitude and latitude of the ID mobile phone, i.e. the longitude and latitude of the ID parking lot, through the satellite navigation system, and uploads them to the server; the server compares the longitude and latitude of the ID mobile phone with the Table of ID Parking Lots and Longitude and Latitude of ID Parking Lots; if the uploaded longitude and latitude of ID mobile phone belongs to the Table of ID Parking Lots and Longitude and Latitude of ID Parking Lots and the parking lot is a non-full parking lot, the server will agree the vehicle to enter the parking lot; 9 is the mobile phone GPS module, including the application for satellite navigation system which contains GPS, BDS system, RGPS system and LBS base station positioning; 10 is to obtain the longitude and latitude of the ID parking lot;

11 is the mobile communication module; 12 is the electronic map display; the electronic map is connected with Tables 1, 2, 3 and 4 of the database; the green indicates non-full stations connected with the Table of Non-full Stations of the database, and the red indicates full stations connected with the Table of Full Stations of the database; furthermore, the green indicates unoccupied parking spaces connected with unoccupied parking spaces in the Table of Non-full Stations of the database, and the red indicates occupied parking spaces connected with occupied parking spaces in the Table of Full Stations of the database; 13 is my account connected with the ID mobile phone account of the database and displayed in real time; 14 is my vehicle location, displaying the location of my car; 15 is the short message prompt module connected with Tables 1, 2, 3 and 4 of the database or the voice prompt module.

FIG. 8 is the illustration diagram of the ID mobile phone APP interface subsystem of an intelligent lock database system with uniquely marked station and longitude and latitude (applicable to shared bicycle and shared car): 1 is the corresponding module of the ID mobile phone APP connected with the corresponding module of the database through mobile network; 2 is the front end (interface) display screen sub-module of the ID mobile phone APP; 3 is the operation bar of the query directory which displays the operation keys for function query 4-13; 4 is the Nearest Non-full Station key, pressing this key will display the total number of non-full stations and unoccupied sub-parking spaces around the driver's location, as well as location marks of full stations; the ID mobile phone APP or electronic map is connected with the Table of Non-full Stations and Table of Full Stations of the database; non-full station is displayed in green and full station is displayed in red in the electronic map; there are also navigation keys, with which the driver can select one of the ID stations to enter the navigation system which will guide the driver to the nearest non-full station; the electronic map is connected with the Table of Full Stations of the database, the full station is displayed in red and vehicles in red station are free to use; vehicle not parked in station is displayed in black; there's short message to remind that the vehicle in red station is free to use; when the passenger's mobile phone is bound to the vehicle in the full station, the server will send a short message to the vehicle unit voice prompt or the Passenger's mobile phone APP to give a notice prompt: (6) “Welcome to use the free vehicle!”; when the passenger starts cycling, the homepage interface will remain open, with the main purpose to guide the passenger to park the vehicle at a non-full station around the passenger; there will be a short message prompting that the vehicle is not parked in station; the electronic map is connected with the Table of ID Vehicles Not Parked in Station of the server, and such vehicle is displayed in black; there will be a short message prompting that the black vehicle is a bonus-gaining vehicle; when the passenger parks the vehicle outside the station, the location of the vehicle will be displayed in the electronic map for the second passenger or staff to query and find; when the second passenger's mobile phone is bound with the vehicle, the server will send a short message to the vehicle unit voice prompt or the passenger's ID mobile phone APP to give a notice prompt: (7) “Welcome to use the bonus-gaining vehicle!”, pressing this key will display non-full stations around the passenger;

5 is the Nearest Unoccupied Parking Space key, after entering a non-full station, pressing this key will display unoccupied parking space around the driver's location, the ID mobile phone APP or electronic map is connected with unoccupied parking spaces and occupied parking space in the non-full parking lot of the database; unoccupied parking space is displayed in green and occupied parking space is displayed in red in the electronic map; there are also navigation keys, with which the driver can select one of the ID parking spaces to enter the cycling navigation system which will guide the driver to the nearest unoccupied parking space; by pressing this key, the driver can check the total number of parking spaces in the station, which is connected with the Table of Unoccupied Parking Spaces of Non-full Stations of the database, and calculate the total number of unoccupied sub-parking spaces in non-full parking spaces, which will be displayed; 6 is the Information on Current Parking Space key, which is used to check shared cars; private owner can check the current location of the shared car, pressing this key will display the current location of the private owner, including longitude and latitude or ID location name; ID mobile phone APP or electronic map is connected with the Table of Unoccupied Parking Spaces and Occupied Parking Spaces of the database, displaying occupied ID sub-parking space in the table; 7 is the Information on Vehicle Not Parked in Station key, pressing the key will display information on the vehicle not parked in station, which is displayed in black; ID mobile phone APP or electronic map is connected with the Table of ID Vehicles Not Parked in Station of the database, when the passenger parks the vehicle outside the station, the location of the vehicle will be displayed in the electronic map for the second passenger or staff to check and find; 8 is the Account Query key, with which the passenger's account can be inquired; the mobile phone APP is bound with bank payment accounts, including third party payment accounts, such as Alipay and WeChat Payment Account, and is connected with the Table of Passenger's Accounts of the server; 9 is My Vehicle key, which is used for shared bicycle query, the Table of Unoccupied Parking Spaces and Table of Occupied Parking Spaces are connected with “My Vehicle Location” of the ID mobile phone APP through mobile network, when the passenger presses this key and inputs the vehicle number, i.e. the ID vehicle, the server will automatically query the Table of Unoccupied Parking Spaces and Table of Occupied Parking Spaces and find out unoccupied packing spaces in the ID station where the ID vehicle is located, and transmit the unoccupied packing spaces in the ID station where the ID vehicle is located to the ID mobile phone, and the longitude and latitude of the non-full ID station and unoccupied ID parking space to the mobile phone APP electronic map, which will be displayed in the electronic map; the main function is to provide information for private car owners to query their vehicle location; or when private car owners query their vehicle location, they can press this key to query my vehicle, and the mobile phone APP or electronic map is connected with the ID vehicle bound with Table of My ID Mobile Phones of the database; the ID vehicle bound with my ID mobile phone is displayed, and the current location of the ID vehicle includes: (a) outside the station and connected with the Table of ID Vehicles Parked Outside the Station of the database, (b) inside the station and connected with the Table of Unoccupied Parking Spaces and Table of Occupied Parking Spaces of the database;

10 is the maintenance upload key. Press this key to take a picture of the vehicle fault and apply for maintenance upload. In case of a vehicle fault, take a picture of the fault location with your mobile phone and upload it to the server; 11 is the free bicycling unit key, which is used for querying the free bicycling unit. The mobile phone APP or electronic map is connected with the table of full stations in the database. When the station reaches the table of full stations, it will be displayed in the free bicycling unit, with the number of free bicycles. When the reached table of full stations is decreased by 1, that is, 1 bicycle in the station is currently free of charge, it aims to encourage passengers to disperse the crowded bicycles in the full station to other stations; 12 is the return key, which is used for returning the bicycle; press the return key to activate the GPS module of mobile phone and upload the longitude and latitude of the mobile phone to the server; 13 is the car owner's message key. The car owner can press this key to query the shared car and send message to the server; for example, the car owner recalls vehicle price concessions and rent pricing of car rentals. 14 is the scan reader; 15 is the ID vehicle mark. At the departure station, the ID mobile phone scans the ID vehicle, binds and uploads this ID vehicle to the server, includes it into the table of ID vehicles and ID mobile phones, and unlocks the bicycle; 16 is scanning ID parking space at the terminal station. In the shared car system, it is used for scanning ID parking space mode to start the GPS module of the ID mobile phone or return the shared bicycle directly, and to upload the longitude and latitude of the ID vehicle or those of the ID mobile phone to the server; 17 is the mobile phone GPS module, including applying for satellite navigation system and GPS system; 18 is the parking space information obtained by the satellite navigation system, including the longitude and latitude, location name or short message; or the parking space information, including the longitude and latitude, location name or short message, is converted into the longitude and latitude and uploaded to the server; 19 is a mobile communication module, and is connected with the server; 20 is the electronic map display. The special electronic map is marked with (1) the mark of the station (parking lot) name, which is connected with the table of station names. Green indicates the “table of non-full stations” connected with the database, and red indicates the “table of full stations” connected with the database; (2) at the same time, vehicles that are not parked in the station are displayed. The vehicle mark of black circle indicates “vehicles not parked in the station”, which are connected with the “table of vehicles not parked in the station” in the database. The “table of vehicles not parked in the station” includes the vehicles that have exceeded the agreed bicycling time (if the agreed bicycling time is 4 hours) or vehicles that have been locked outside the station. The “table of vehicles not parked in the station” includes the vehicles that have exceeded the agreed bicycling time (if the agreed bicycling time is 4 hours) or vehicles that have been locked outside the station. 21 is my account, which is connected with the ID mobile phone account of the background system and displayed in real time;

22 is location of my vehicle, showing the location of the car bound to the private car, which is used for shared car; 23 is short message prompt, which may include voice prompt of mobile phone; it prompts with the background system that “park in the recommended parking space” and is connected with the table of non-full parking spaces; it prompts with the background system that “query and park in the nearest non-full station”; The whole procedure ends with the last short message sent by the server or the voice prompt of the mobile phone. Note: If the vehicle unit GPS return mode is adopted, that is, the return key or mode of scanning vehicle mark is not adopted, the 12 return key or the 15 parking space mark will be deleted.

FIG. 9 is the computer program of an intelligent lock database system with uniquely marked delivery station and longitude and latitude:

Procedure for staff to deliver the mail: 1 is Step 1: the staff determines the nearest ID delivery station according to the region of the customer's mailing address, puts the ID mail of the customer's ID mobile phone into the ID sub-location mailbox of the ID delivery station, and locks the ID sub-intelligent lock of the ID sub-location mailbox; 2 is Step 2: the staff binds the customer's ID mobile phone, ID mail, ID delivery station, ID delivery station computer, ID location, ID sub-location and ID sub-intelligent lock of ID sub-location using the work mobile phone, and includes it in the table of ID mobile phones and ID locations, as shown in Table 11; and uploads the table to the database of the server; the GPS module of the work mobile phone uploads the longitude and latitude of ID delivery station and those of ID location to the server through the satellite navigation system; the ID delivery station is provided with an ID delivery station computer; the ID delivery station computer is connected with the ID sub-intelligent lock, which is opened or closed through the industrial control unit; 3 is Step 3: the server database transmits the information of “ID mail, ID delivery station, ID location and ID sub-location” in the table to the customer's ID mobile phone APP; the table of ID mobile phones and ID locations in the database is connected with the electronic map, and the longitude and latitude of ID delivery station and those of ID location are displayed in the electronic map of the customer's ID mobile phone; a short message or call is made to inform the customer's ID mobile phone that “you have one ID mail, please take it according to the delivery station given in your mobile phone APP; ID sub-location mailbox (i e mailbox number) is informed to the customer. “Procedure for customer to take the mail: 4 is Step 4: after receiving the above information from the server and seeing the location of ID delivery station in the ID mobile phone APP, the customer goes to the ID delivery station, stands on the designated ID location and ID sub-location mailbox (i.e. mailbox number), and presses the mail taking key in the ID mobile phone APP; the GPS module of the customer's ID mobile phone uploads the longitude and latitude of ID mobile phone and those of ID location to the server through the satellite navigation system; and uploads the request of “mail taking key”, the ID mobile phone and its longitude and latitude to the server through the ID mobile phone; 5 is Step 5: after receiving the request of “mail taking key” from the customer's ID mobile phone, the server starts the instruction procedure: (1) Step 1: comparing the longitude and latitude of the customer's ID mobile phone with the table of ID locations and their longitudes and latitudes; if the longitude and latitude of the customer's ID mobile phone belongs to those of the ID location in the table, it will instruct the ID delivery station computer to open the ID sub-intelligent lock of the ID location; (2) Step 2: comparing the customer's ID mobile phone with the table of customer's ID mobile phones and ID locations; if the customer's ID mobile phone belongs to the ID mobile phone corresponding to the ID sub-location in the table, the ID location intelligent lock corresponding to the ID sub-location can be obtained, and then the instruction of the ID location intelligent lock corresponding to the ID sub-location can be opened; logical relationship: two switches are necessary to open the ID location intelligent lock: (1) switch of ID location, with the purpose to confirm that the longitude and latitude of the customer's ID mobile phone correspond to those of the ID location one to one; (2) switch of ID sub-intelligent lock, with the purpose to confirm that the customer's ID mobile phone corresponds to the ID sub-intelligent lock of the ID sub-location mailbox one by one; that is, (1) only when the longitude and latitude of the customer's ID mobile phone belongs to those of a certain ID location given in the table of ID locations and their longitudes and latitudes, it will instruct the ID delivery station computer to open the ID sub-intelligent lock of the ID location; (2) only when the customer's ID mobile phone belongs to the ID sub-location in the table of customer's ID mobile phones and ID locations, the instruction of ID sub-intelligent lock can be opened; only when both conditions are met at the same time, the ID delivery station computer can be instructed to open the ID sub-intelligent lock, and the customer can take out the ID mail; otherwise, it cannot be opened; for example: ID mail is number y168, ID mobile phone is mobile phone number 168; departure station: ID delivery station is East Gate Station with number z36, ID location number is zc8 parking space number, and ID sub-location number is zcz6.

FIG. 10 is a flow chart of the computer program of an intelligent lock database system with uniquely marked parking lot and longitude and latitude:

1. First, the driver downloads the mobile phone APP of the parking lot, and presses the nearest non-full parking lot key of the ID mobile phone, that is, the driver uploads the longitude and latitude of the ID mobile phone to the server, and the server compares them with the table of ID parking lots and their longitudes and latitudes in the database to obtain the nearest non-full parking lot, which is transmitted and displayed in the driver's ID mobile phone interface and the electronic map; the non-full ID parking lot is displayed in green in the electronic map; then the driver arrives at the nearest non-full ID parking lot according to the guidance displayed in the ID mobile phone interface or electronic map; 2. When entering the parking lot, the driver selects the parking mode; there are two parking modes: (A) pressing the parking key; (B) scanning the ID parking lot (QR code); the driver uses the ID mobile phone to upload the longitude and latitude of ID mobile phone (i.e. longitude and latitude of ID parking lot) to the server; then the server obtains the instruction of “permission to lock” to the parking lot computer according to the instruction computer program (algorithm) as shown in FIG. 6, otherwise, it will not issue the instruction of “permission to lock”;

The parking lot computer or parking lot intelligent lock comprises the license plate number recognition system with an access gate at the entrance and exit of the parking lot, which records the unique license plate number of the vehicle of ID mobile phone which is represented by an ID vehicle, and uploads the ID vehicle to the server through the Internet; the server binds the ID vehicle, ID mobile phone and ID parking lot, and includes them in the table of ID mobile phones and ID parking lots (see Table 7); the server is provided with a timer,

which records the entry time in the ID mobile phone account and starts timing and transmits it to the account of the ID mobile phone APP;

The parking lot computer uploads Table 7 to the server; the intelligent lock of the parking lot gate opens the lock and the ID vehicle enters;

3. The server compares the longitude and latitude of ID parking lot with the table of ID parking lots and their longitudes and latitudes, and they conform to the longitude and latitude of ID parking lot in the table; if the ID parking lot belongs to the table of non-full parking lots, the ID parking lot is bound with the ID mobile phone and included in the table of ID mobile phones and ID parking lots; the unlocking instruction is transmitted to the parking lot computer through wireless communication, that is, the server obtains the unlocking instruction to the passenger's ID mobile phone according to the instruction (algorithm) computer program; the instruction (algorithm) computer program of an intelligent lock database system with uniquely marked parking lot and longitude and latitude is as shown in FIG. 4;

4. The parking lot computer receives the unlocking instruction from the server, the intelligent lock of the parking lot gate opens the lock, the ID vehicle enters, and starts to count the parking time; the parking space layout of non-full ID parking lot is arranged at the entrance or intersection of the non-full ID parking lot, and the non-full parking spaces are displayed with green lights in the layout; 5. The non-full parking spaces may be displayed in the layout of non-full ID parking spaces of the ID parking lot in the electronic map of the driver's ID mobile phone; the driver presses the nearest non-full parking space key of the ID mobile phone, that is, the driver uploads the longitude and latitude of the ID mobile phone to the server, and the server compares them with the table of ID parking spaces and their longitudes and latitudes in the database to obtain the nearest non-full parking space, which is transmitted and displayed in the driver's ID mobile phone interface and the electronic map; the non-full ID parking space is displayed in green in the electronic map; then the driver arrives at the nearest non-full ID parking space according to the guidance displayed in the ID mobile phone interface or electronic map;

6. In the ID parking space, when the driver presses the mobile phone APP to scan the ID parking space (including QR code), the server or parking lot computer binds the ID parking space (including QR code) and ID sub-parking space with ID mobile phone and ID vehicle, and includes them into the table of ID mobile phones and ID parking lots of the parking lot; or the server queries the longitude and latitude from the table of ID parking spaces and their longitudes and latitudes in the database according to the longitude and latitude of the driver's ID mobile phone, binds the ID parking space (including QR code) and ID sub-parking space with ID mobile phone and ID vehicle, and includes them into the table of ID mobile phones and ID parking lots of the parking lot;

7. The GPS module of ID mobile phone obtains ID mobile phone (i.e. ID mobile phone number) and longitude and latitude of the ID mobile phone through satellite navigation system; uploads the ID mobile phone (i.e. ID mobile phone number) and longitude and latitude of the ID mobile phone (i.e. longitude and latitude of non-full ID parking space) to the server, and the server compares the longitude and latitude of the ID parking space with the table of ID parking spaces and their longitudes and latitudes to confirm that they conform to the longitude and latitude of a certain ID parking space in the table; at the same time, it obtains the name of the ID parking space, and compares it with the table of non-full parking lots to confirm that the ID parking space is non-full. Sensors (including infrared sensors) are installed above, below or on the side of the vehicle in the sub-parking space of ID parking space; the sensors acquire and upload the ID vehicle entry information to the parking lot computer unit or server, which then binds the ID parking space with the ID mobile phone, binds the ID parking space or the sub-parking space of ID parking space with the ID mobile phone, and includes the ID parking space or the sub-parking space of ID parking space to the occupied ID parking space or the sub-parking space of ID parking space in the table of unoccupied parking lots; the unoccupied ID parking space or sub-parking space of ID parking space in the table of unoccupied parking lots become the occupied ID parking space or sub-parking space of ID parking space in the table of unoccupied parking lots; in the parking lot without longitude and latitude signal of ID parking space, such as underground parking lot, it is only necessary to bind the sub-parking space of ID parking space with the ID mobile phone, and include them in the sub-parking space component of ID parking space in the table of non-full ID parking lots: (1) vehicle entry sensors are installed above, below or on the side of the parking space of ID parking space; when the ID vehicle enters the sub-parking space of ID parking space, the vehicle sensors upload the entry information to the parking lot computer system or server; it is only necessary to bind the sub-parking space of ID parking space with the ID mobile phone, and include them in the sub-parking space component of ID parking space in the table of non-full ID parking lots: (2) the charge unit of the parking lot computer system or server records the parking time of the ID vehicle, i.e. it starts charging;

8. The server transmits the ID parking lot, ID parking space and starting time of parking to the driver's ID mobile phone; 9. When the ID vehicle leaves the ID parking space, the sensors acquire and upload the ID vehicle exit information to the parking lot computer unit or server, which then unbinds the ID parking space and the ID mobile phone, and includes the ID sub-parking space in the unoccupied ID sub-parking space in the table of unoccupied stations; the sub-parking space of the occupied ID parking space in the table of unoccupied parking lots becomes the sub-parking space of the unoccupied ID parking space in the table of unoccupied parking lots; 10. An outbound unit license plate recognition system is arranged at the entrance of the parking lot to record the license plate of the ID vehicle, i.e. the ID vehicle, unbind the ID parking lot and the ID vehicle (license plate of the vehicle), record the departure time, and include it in the table of ID parking lots and ID vehicles leaving the parking lot; or the driver presses the exit parking lot key or uses the mobile phone APP to scan the QR code of ID parking lot to unbind the ID parking lot and the ID vehicle (license plate of the vehicle), record the departure time, and include it in the table of ID parking lots and ID vehicles leaving the parking lot; the parking lot computer uploads the table of ID parking lots and ID vehicles leaving the parking lot to the server; the intelligent lock of the parking lot gate opens the lock, the ID vehicle leaves, and the counting of parking time is finished; when leaving the parking lot: the parking lot computer or parking lot intelligent lock comprises the license plate number recognition system with an access gate, which records the ID vehicle (license plate number) and uploads the ID vehicle to the server through the Internet; the server records the departure time in the account of ID mobile phone, calculates the parking time and parking fee, and transmits them to the account of the ID mobile phone APP; then the parking procedure is completed.

11. The parking lot computer uploads the table of ID parking lots and ID vehicles leaving the parking lot to the server; the intelligent lock of the parking lot gate opens the lock, the ID vehicle leaves, and the counting of parking time is finished; the parking fee is calculated and deducted from the bank account bound by the driver's mobile phone; the departure time is transmitted to the parking lot computer system or server, which calculates the parking fee and includes it to the mobile phone account of the vehicle's driver, that is, deducts it from the bank account bound by the driver;

12. The server transmits the parking time and deducted parking fee to the driver's ID mobile phone APP. 13 is the driver, 14 is the driver's ID mobile phone APP, 15 is the server, 16 is the parking lot computer or ID intelligent lock, 17 is the ID location and its longitude and latitude, and 18 is the ID parking lot and its longitude and latitude. For example: ID vehicle is number c27; ID mobile phone is mobile phone number 128; departure station: ID parking lot is East Gate Station with number z39, ID parking lot number is zc5, and ID sub-parking space number is zcz3.

FIG. 11 is a flow chart of the module of pressing the return key or scanning the parking space (station) mark (QR code) of the computer program of an intelligent lock database system with uniquely marked station and longitude and latitude (applicable to shared bicycles and shared cars):

1. First, the passenger downloads the mobile phone APP used for shared bicycles and cars of this technology, and opens the ID mobile phone to scan the QR code of ID vehicle; 2. The ID mobile phone or ID vehicle uploads the information such as the longitude and latitude of ID vehicle and those of ID mobile phone to the server; 3. The server verifies whether the ID mobile phone account complies with the regulations and has funds and whether it is included in blacklists. After verifying its compliance, the ID vehicle and ID mobile phone will be bound and included in the table of ID vehicles and ID mobile phones; the unlocking instruction is returned to the ID vehicle, the control module of the ID vehicle unlocks, deletes the binding between the ID vehicle and the ID sub-parking space of ID parking space at the departure station simultaneously and stores it in the table of ID vehicles and (departure station) ID stations in the database, and changes the occupied ID sub-parking space of the departure station to the unoccupied ID sub-parking space; 4. ID vehicle uploads the unlocking information to the server;

5. The server will start charging and transmit it to the ID mobile phone; the passenger starts bicycling/driving; 6. When arriving at the terminal station, the passenger opens the ID mobile phone to press the return key or scan the ID parking space (including QR code). 7. The ID mobile phone applies to the server for locking the vehicle, and uploads the longitude and latitude of ID mobile phone (i.e. longitude and latitude of ID parking space) and the ID mobile phone to the server; 8. The server compares the uploaded longitude and latitude of ID mobile phone or those of ID vehicle (i.e. longitude and latitude of ID parking space) with the table of ID parking spaces and their longitudes and latitudes in the database. If the uploaded longitude and latitude of ID mobile phone (i.e. longitude and latitude of ID parking space) is the longitude and latitude of a certain parking space given in the table of ID parking space marks and their longitudes and latitudes, and at the same time, the ID parking space belongs to the non-full ID parking spaces given in the table of non-full ID stations, the server will issue an instruction of permission to lock to the passenger's ID mobile phone or ID vehicle according to the instruction (algorithm) computer program (the instruction (algorithm) computer program of an intelligent lock database system with uniquely marked station and longitude and latitude as shown in FIG. 5);

9. The passenger (or driver) receives the locking instruction through the ID mobile phone from the server and locks the car within the specified time; a timer is provided in the basic table of locking instruction, and the timer starts timing when the instruction is sent; the passenger must lock the car within the specified time, which can be 30-120 s; after the specified time, the server will stop or withdraw the locking instruction, with the purpose to urge the passenger to park the vehicle within the parking space of the station; or the ID vehicle cannot directly lock the vehicle when it does not receive the locking instruction from the server; the passenger can directly lock the vehicle only when the ID vehicle receives the locking instruction from the serve; then the ID vehicle or ID mobile phone uploads the locking information to the server; 10. The server calculates the fare according to the traveling time or distance, includes it in the passenger's bank account and transmits it to the mobile phone APP; the ID vehicle is deleted from the table of ID vehicles and ID mobile phones; the ID vehicle is bound with the ID sub-parking space and included in the table of non-full ID stations; then the procedure is completed. 11 is the passenger; 12 is the passenger's mobile phone APP, including a scanner, 13 is the server, and 14 is the vehicle unit; 15 is the parking space (station) unit, including parking space mark (QR code) and its longitude and latitude.

The permissible error range of ID station and longitude and latitude of ID station is large, which can be within 20 m in diameter; the permissible error range of ID parking space and longitude and latitude of ID parking space is small, which can be within 10 m in diameter; ID parking space is included in ID station, and the longitude and latitude of ID parking space is included in those of ID station, that is, the longitude and latitude of ID parking space is within the longitude and latitude of ID station, or not within the longitude and latitude of ID station; it is specified that only when the longitude and latitude table of the ID vehicle intelligent lock corresponds to a certain ID parking space mark in the table of ID parking space marks and their longitudes and latitudes one to one, that is, the longitude and latitude of the ID vehicle are equal to those of the ID parking space, or the error is within a limited range (the limited range includes 10 m), the vehicle can be locked; at the terminal station, the longitude and latitude of ID vehicle (i.e. longitude and latitude of ID parking space) are uploaded; the passenger must park the vehicle in ID parking space, and the longitude and latitude of the ID parking space must conform to the table of ID parking spaces and their longitudes and latitudes; the passenger selects the return mode; there are three return modes: (A) pressing the return key, (B) scanning the station QR code by ID mobile phone, both modes mean that the GPS module of ID mobile phone uploads the longitude and latitude of ID mobile phone (i.e. longitude and latitude of ID parking space) to the server; (C) the passenger directly locks the vehicle manually, when locking, the intelligent lock of ID vehicle starts the GPS module of ID vehicle and uploads the longitude and latitude of ID vehicle (i.e. longitude and latitude of ID parking space) to the server; the passenger can select any one of the above three modes; the server compares the uploaded longitude and latitude of ID parking space mark with the table of ID parking space marks and their longitudes and latitudes, and obtains the ID parking space; compares them to the table of non-full parking spaces; if the uploaded longitude and latitude of ID parking space mark conform to the table of ID parking space marks and their longitudes and latitudes, and the ID parking space belongs to the table of non-full parking spaces, the server will issue an instruction of permission to lock to the vehicle unit, otherwise, it will not issue an instruction of permission to lock; the purpose and function of ID mobile phone or ID vehicle unit to control ID vehicle intelligent lock through the server are achieved; at the same time, the ID vehicle is bound with the ID sub-parking space of ID parking space of the terminal station and stored in the table of ID vehicles and (terminal station) ID stations in the database; the unoccupied ID sub-parking space of the terminal station changes to the occupied ID sub-parking space and is included in the table of occupied ID parking spaces. The ID parking space of terminal station and the parking space of departure station are interchangeable.

FIG. 12 is a flow chart of the return mode with a second passenger (taking the GPS module of the vehicle unit as an example) of an intelligent lock database system with uniquely marked station and longitude and latitude (applicable to shared bicycles):

1. The passenger uses the ID mobile phone to scan the QR code of ID vehicle; 2. The ID mobile phone uploads the ID vehicle and ID mobile phone to the server; 3. The server returns the unlocking instruction to the vehicle unit; 4. The intelligent lock control module of the ID vehicle unlocks and uploads the unlocking information to the server; 5. The server binds the ID vehicle with the ID mobile phone and includes it in the table of ID vehicles and ID mobile phones; 6. The passenger selects the return mode; 7. The passenger arrives at the terminal station and starts the return mode, and adopts the manual direct locking mode; 8. The GPS module of the ID mobile phone or ID vehicle obtains the longitude and latitude of the ID station through the satellite navigation system; 9. The ID mobile phone or ID vehicle uploads the longitude and latitude of ID parking space to the server; 10. The server compares the uploaded longitude and latitude of ID parking space with the table of parking space marks and longitudes and latitudes of ID parking spaces in the database, and the server issues an instruction of permission to lock to the passenger's ID mobile phone or ID vehicle according to the instruction (algorithm) computer program; the fare is included in the passenger's account and transmitted to the mobile phone APP, and the ID vehicle is deleted from the table of ID vehicles and ID mobile phones; the ID vehicle is bound with the ID parking space and included in the table of non-full stations.

11. The passenger fails to select the return mode, and the first passenger parks the vehicle outside the station. At this time, it is impossible to lock the vehicle directly, and the ID vehicle intelligent lock will give a voice prompt (10) “If you park the vehicle outside the station, please press the “emergency key” to lock the vehicle”. After the passenger presses the “emergency key”, the server will issue an instruction of permission to lock to the ID vehicle intelligent lock; the first passenger locks the ID vehicle directly at the location outside the station, which is referred to as the second departure station; the ID vehicle intelligent lock or ID mobile phone uploads the parking longitude and latitude to the server, and the server binds the ID vehicle with the longitude and latitude of the location outside the station and includes it in the table of ID vehicles and longitudes and latitudes of locations outside the station; (See Table 9) the table is stored in the database; at the same time, the server converts the table of first passenger's ID mobile phone and ID vehicle into the table of ID vehicle and second passenger's ID mobile phone in the database, as shown in Table 10 below; at the same time, the timer of waiting time starts timing until the second passenger's ID mobile phone scans the ID vehicle, the ID vehicle intelligent lock opens, the timer stops timing, and the waiting fee is included in the table of ID vehicle and second passenger's ID mobile phone, and the waiting fee=waiting time*waiting rate; the timer of waiting time starts timing; 12. First, the second passenger downloads the mobile phone APP used for shared bicycles, and uses the ID mobile phone to scan the QR code of ID vehicle; 13. The ID mobile phone of the second passenger uploads the information of ID vehicle and his/her ID mobile phone to the server; 14. The server verifies the second passenger's ID mobile phone account, returns the unlocking instruction to the ID vehicle, and the control module of the ID vehicle intelligent lock unlocks; 15. The ID vehicle intelligent lock uploads unlocking information to the server; 16. The server binds the ID vehicle with the second passenger's ID mobile phone and includes it in the table of ID vehicle and second passenger's ID mobile phone; the timer of waiting time stops timing; it starts billing of the second passenger and transmits the ID vehicle to the second passenger's mobile phone APP; the second passenger starts bicycling; 17. The second passenger arrives at the terminal station and starts the return mode, such as manually pressing the car lock; 18. The GPS module of ID mobile phone or ID vehicle obtains the longitude and latitude of ID station through the satellite navigation system; 19. The ID mobile phone or ID vehicle uploads the longitude and latitude of ID parking space to the server; 20. The server compares the uploaded longitude and latitude of ID vehicle (i.e. longitude and latitude of ID station) with the table of ID parking spaces and THEIR longitudes and latitudes (see Table 2). If they conform to Table 2 and the ID parking space belongs to the table of non-full parking spaces (see Table 4), the server will issue an instruction of permission to lock to the passenger's ID mobile phone or ID vehicle according to the instruction (algorithm) computer program; the server calculates the fare according to the traveling time or distance of the second passenger, and includes the bonus to the second passenger's account; or it deducts the default fine from the first passenger's account, includes it into the second passenger's account as a bonus, and transmits it to the second passenger's mobile phone APP; the ID vehicle is deleted from the table of ID vehicle and second passenger's ID mobile phone; the ID vehicle is bound with the ID parking space and included in the table of non-full stations.

FIG. 13 is a flow chart of the vehicle unit GPS module of an intelligent lock database system with uniquely marked station and longitude and latitude (applicable to shared bicycles):1 is Step 1: the ID mobile phone APP scans the QR code of ID vehicle; 2 is Step 2: the ID mobile phone uploads the ID vehicle and ID mobile phone to the server; 3 is Step 3: the server binds the ID vehicle and ID mobile phone and includes them in the table of ID vehicles and ID mobile phones; it will issue an unlocking instruction to the ID vehicle; 4 is Step 4: the ID vehicle intelligent lock uploads the unlocking information to the server; 5 is Step 5: the server starts billing the ID mobile phone and transmits the billing to the ID mobile phone APP; 6 is Step 6: after arriving at the terminal station, the passenger locks the bicycle manually; 7 is Step 7: the ID vehicle intelligent lock starts the GPS module; 8 is Step 8: the wireless communication module of ID vehicle intelligent lock uploads the longitude and latitude of ID vehicle (i.e. longitude and latitude of ID parking space) to the server through the mobile network; 9 is Step 9: the server issues an instruction of permission to lock to the passenger's ID mobile phone or ID vehicle according to the instruction (algorithm) computer program; 10 is the passenger; 11 is the passenger's ID mobile phone APP, including a scanner, 12 is the server, and 13 is the vehicle unit; 14 is the parking space (station) unit, including parking space mark (QR code) and its longitude and latitude.

### DETAILED DESCRIPTION OF THE EMBODIMENTS

A flow chart of the vehicle unit GPS module of an intelligent lock database system with uniquely marked station and longitude and latitude (applicable to shared bicycles): for example: ID vehicle is number c23; ID mobile phone is mobile phone number 123; departure station: ID station is East Gate Station with number z34, ID parking space number is zc2 and ID sub-parking space number is zcz2. Terminal station: ID station is West Gate Station with number z65, ID parking space number is zc6 and ID sub-parking space number is zcz1.

1 is Step 1: the vehicle parks at the departure station (ID station is East Gate Station with number z34), with ID parking space (number zc2) and ID sub-parking space (number zcz2); the passenger opens the ID mobile phone (mobile phone number 123) APP to scan the QR code of ID vehicle (number c23); 2 is Step 2: the ID mobile phone or vehicle unit uploads the information of ID vehicle and ID mobile phone to the server; 3 is Step 3: the server verifies whether the ID mobile phone account complies with the regulations and has funds and whether it is included in blacklists. After verifying its compliance, the ID vehicle (number c23) and ID mobile phone (mobile phone number 123) will be bound and included in the table of ID vehicles and ID mobile phones; the unlocking instruction will be issued to the ID vehicle, the control module of the ID vehicle unlocks, and the server deletes the binding between the ID vehicle (number zc2) and the ID sub-parking space (number zcz2) of ID parking space (number zc2) at the departure station (East Gate Station with number z34); 4 is Step 4: the intelligent lock of ID vehicle uploads the unlocking information to the server; 5 is Step 5: the server starts billing the ID mobile phone and transmits the billing to the ID mobile phone APP; the passenger starts bicycling; 6 is Step 6: the passenger arrives at the terminal station (ID station is West Gate Station with number z65, ID parking space number is zc6 and ID sub-parking space number is zcz1) and locks the bicycle manually; 7 is Step 7: when locking, the ID vehicle intelligent lock starts the GPS module to obtain the longitude and latitude of ID vehicle (number c23), i.e. the longitude and latitude of ID parking space (number zc2) through the satellite navigation system; 8 is Step 8: the wireless communication module of ID vehicle intelligent lock uploads the longitude and latitude of ID vehicle (i.e. longitude and latitude of ID parking space) to the server through the mobile network;

What is claimed is:

1. An intelligent lock database system based on uniquely marked location and longitude and latitude, which is characterized by;
the area contains a number of uniquely marked gathering stations which are expressed as ID gathering stations, each ID gathering station contains at least one uniquely marked location which is expressed as ID location, and each ID location contains at least one uniquely marked sub-location which is expressed as ID sub-location;
the longitude and latitude of the ID gathering station are measured with the longitude and latitude location positioning system on the spot, and all ID gathering stations in the whole area are bound with the longitude and latitude of ID gathering stations one to one and stored in the table of ID gathering stations and longitude and latitude of ID gathering stations in the database;
the longitude and latitude location positioning system is hereinafter referred to as GPS system;
the longitude and latitude of the ID location are measured with the GPS system on the spot, and all ID locations in the ID gathering station are bound with the longitude and latitude of ID locations one to one and stored in the table of ID locations and Longitude and Latitude of ID Locations in the database; there are one-to-one corresponding uniquely marked intelligent locks at the ID locations, and the uniquely marked intelligent locks are expressed as ID intelligent locks, that is, the longitude and latitude of ID location are in one-to-one correspondence with the longitude and latitude of ID intelligent lock; the ID intelligent lock is provided with SIM card and GPS system module;
it contains a number of uniquely marked mobile phones which are expressed as ID mobile phones, and each ID mobile phone is provided with SIM card and GPS system module;
the said ID intelligent lock, said ID mobile phone and GPS system communicate with the server through a wired or wireless network;
the way the ID mobile phone to open or close the ID intelligent lock through the server is as follows: The ID mobile phone can open or close the ID intelligent lock through the server only when the longitude and latitude of the ID location correspond to the longitude and latitude of the ID intelligent lock one to one and when the longitude and latitude of the ID location correspond to the longitude and latitude of the ID mobile phone one to one; and
that is, the ID mobile phone uploads the longitude and latitude of the ID mobile phone to the server through the GPS system, and the server compares the longitude and latitude of the ID mobile phone, i.e. the uploaded longitude and latitude of ID location, with those in the table of ID locations and longitude and latitude of ID locations; only when the uploaded longitude and latitude of ID location correspond to the longitude and latitude of a certain ID location in the table of ID locations and longitude and latitude of ID locations one to one, the instruction to open or close the ID intelligent lock can be sent to the ID intelligent lock one-to-one corresponding to the longitude and latitude of the ID location.

2. An intelligent lock database system with uniquely marked delivery station and longitude and latitude, which is characterized by: It is applicable to the intelligent lock database system based on uniquely marked location and longitude and latitude as said in claim 1;
the whole area is provided with a number of delivery stations, each delivery station is registered as uniquely marked delivery station and expressed as ID delivery station, the longitude and latitude of the ID delivery station are measured on the spot, and all ID delivery stations in the whole area are bound with the longitude and latitude of ID delivery stations one to one and included in the table of ID delivery stations and longitude and latitude of ID delivery stations which is stored in the database;
each ID delivery station is provided with at least one ID location whose longitude and latitude are measured on the spot, all ID locations in the delivery station are bound with the longitude and latitude of ID locations one to one and included in the table of ID locations and longitude and latitude of ID locations which is stored in the database; each ID location is provided with a number of sub-locations, each sub-location has a unique code and expressed as ID sub-location; each ID sub-location is provided with a mailbox which is provided with an ID intelligent lock; 1 sub-location can only be placed with one ID email of ID mobile phone;
each ID sub-location (mailbox) is bound with the ID intelligent lock; the said mailbox may contain intelligent locks for milk delivery box and home door;
the customer's uniquely marked mail is expressed as ID mail, and the customer's mobile phone is expressed as ID mobile phone;
staff mobile phone, ID mobile phone, GPS system and server communicate with each other through wireless network; and
procedure for delivering mail: The staff puts the ID mail into the ID sub-location mailbox and locks the ID intelligent lock of the ID sub-location which is referred to as ID sub-location intelligent lock for short; the staff uses his/her mobile phone to record the ID mobile phone, ID delivery station, ID location, ID sub-location (mailbox), ID sub-location intelligent lock and ID mail in the table of ID mobile phones and ID locations (see Table 7), and uploads the table to the server and stores it in the database, and then the server transmits the table to the customer's ID mobile phone; as shown in the table, the ID mail of customer's ID mobile phone is put into ID sub-location 2.

3. An intelligent lock database system with uniquely marked parking lot and longitude and latitude, which is characterized by: It is applicable to the intelligent lock database system based on uniquely marked location and longitude and latitude as said in claim 1;
the whole area is provided with two or more parking lots, each parking lot is registered as uniquely marked parking lot and expressed as ID parking lot, and the unique mark said below may include a QR code; the longitude and latitude of the ID parking lot are measured on the spot; all ID parking lots in the whole area are bound with the longitude and latitude of ID parking lots one to one and included in the table of ID parking lots and longitude and latitude of ID parking lots (see Table 1); the table is stored in the database;
each ID parking lot contains at least one uniquely marked parking space which is expressed as ID parking space; the longitude and latitude of the ID parking space are measured on the spot; the ID parking spaces are bound with the longitude and latitude of the ID parking spaces one to one and included in the table of ID parking spaces and longitude and latitude of ID parking spaces (see Table 2); the table is stored in the database; each ID parking space is composed of at least one uniquely marked sub-parking space which has a unique code and expressed as ID sub-parking space; 1 sub-parking space can only be occupied by one vehicle;
the ID parking lot is provided with ID parking lot computer which is referred to as ID intelligent lock; the ID intelligent lock is connected with the industrial control module to control the opening and closing of the entrance and exit lock of the ID parking lot, and is provided with SIM card and longitude and latitude positioning system module; the ID intelligent lock may also be called ID parking lot;
when all parking spaces of a ID parking lot are fully occupied, the ID parking lot is considered as a full parking lot, and all full parking lots are included in the table of full parking lots (see Table 3); the table is stored in the database; when at least one parking space of the ID parking lot is not occupied, the ID parking lot is considered as a non-full parking lot, and all non-full parking lots are included in the table of non-full parking lots (see Table 4); the table is stored in the database;
when all sub-parking spaces of a parking space are occupied sub-parking spaces, the ID parking space is considered as an occupied parking space, all occupied parking spaces in the whole area are included in the occupied parking spaces in the table of full and non-full parking lots (see Table 3), and the table is stored in the database; when the ID is occupied and at least one sub-parking space is unoccupied sub-parking space, the ID parking space is considered as an unoccupied parking space, and all unoccupied parking spaces are included in the unoccupied parking spaces in the Table of Non-full Parking Lot (see Table 3); the table is stored in the database;
it contains a number of drivers' mobile phones which are expressed as ID mobile phones, and each ID mobile phone is provided with SIM card and GPS system module; the ID parking lot computer, ID mobile phone and GPS system are connected to the server through wireless network;
the driver enters, presses the key of entering the parking lot on the ID mobile phone or scans QR code in the ID parking lot, and uploads the longitude and latitude of the ID mobile phone to the server, then the server compares them with those in the table of longitude and latitude of ID parking lots and ID parking lot computers; only when the longitude and latitude of the ID parking lot correspond to the longitude and latitude of the ID mobile phone one to one, the ID parking lot can be accessed; if the ID parking lot belongs to the table of non-full parking lots, the server will send an instruction to the ID parking lot computer to open the gate, and then the ID mobile phone can open the entrance gate switch on the ID parking lot computer;

4. An intelligent lock database system with uniquely marked station and longitude and latitude, which is characterized by: It is applicable for the intelligent lock database system based on uniquely marked location and longitude and latitude as said in claim 1; (used for shared bicycle and shared car)
the whole area is provided with two or more stations, and each station is registered as uniquely marked station and expressed as ID station; the longitude and latitude of the ID station are measured on the spot; all ID stations in the whole area are bound with the longitude and latitude of ID stations one to one and included in the table of ID stations and longitude and latitude of ID stations (see Table 1); the table is stored in the database;
each ID station contains at least one uniquely marked parking space which is expressed as ID parking space; the longitude and latitude of the ID parking space are measured on the spot; the ID parking spaces are bound with the longitude and latitude of the ID parking spaces one to one and included in the table of ID parking spaces and longitude and latitude of ID parking spaces (see Table 2); the table is stored in the database; each ID parking space is composed of at least one sub-parking space, and each ID sub-parking space can only be occupied by one vehicle;
when all parking spaces of a ID station are fully occupied, the ID station is considered as a full station, and all full stations are included in the table of full stations (see Table 3); the table is stored in the database; when at least one parking space in ID parking lot is not occupied, the ID station is considered as a non-full station, and all non-full stations are included in the table of non-full stations (see Table 4); the table is stored in the database;
it contains more than two intelligent locks, and each intelligent lock is registered as uniquely marked intelligent lock and expressed as ID intelligent lock; the ID intelligent lock is provided on the uniquely marked vehicle, the unique mark contains QR code, and the uniquely marked vehicle is expressed as ID vehicle; the ID intelligent lock is connected with the industrial control module to control opening and closing of the lock of the ID vehicle, and the ID intelligent lock is provided with SIM card and longitude and latitude positioning system module; the ID intelligent locks correspond to the ID vehicles one to one; and
it contains a number of passenger uniquely marked mobile phones which are expressed as ID mobile phones, and each ID mobile phone is provided with SIM card and GPS system module; each ID intelligent lock, ID mobile phone and GPS system communicate with the server through wired or wireless network; at the departure station, the passenger uses the ID mobile phone to scan the ID vehicle, binds the ID mobile phone with the ID vehicle, and stores in the ID mobile phone or table of ID vehicles; at the same time, the server changes the occupied ID sub-parking space of the departure station into an unoccupied ID sub-parking space, and include it into the unoccupied ID sub-parking spaces in the table of non-full parking lots; when arriving at the terminal station, the passenger directly locks the vehicle or scans the ID parking space QR code and uploads the longitude and latitude of the ID mobile phone or the longitude and latitude of the ID vehicle (i.e. longitude and latitude of the ID parking space) to the server, and the server compares the uploaded longitude and latitude of the ID parking space with those in the table of ID parking spaces and longitude and latitude of ID parking spaces; only when the uploaded longitude and latitude of the ID parking space correspond to some longitude and latitude of the ID parking space in the table of ID parking spaces and longitude and latitude of ID parking spaces, that is, corresponding to the longitude and latitude of the ID mobile phone, the ID parking space can be accessed; the server compares the ID parking space with that in the table of non-full stations; if the ID parking space belongs to some unoccupied ID parking space in the table of non-full stations, the server will send an instruction to the ID mobile phone or ID intelligent lock to open the gate; only the ID mobile phone or ID intelligent lock can open the industrial control switch of the ID intelligent lock, each ID intelligent lock is provided with industrial control module that is connected with the vehicle lock switch of the ID vehicle to control the vehicle lock switch of the ID vehicle, and when the ID intelligent lock receives the server's instruction to open the vehicle lock, the ID intelligent lock industrial control module will control to open the vehicle lock of the ID vehicle, and vice versa.
